(19) United States
(12) Patent Application Publication
(10) Pub. No.: US 2009/0136908 A1
(43) Pub. Date: May 28, 2009

(54) MATHEMATICS TEACHING METHOD

(76) Inventor: Candace Smothers, Sevierville, TN (US)

Correspondence Address: LUEDEKA, NEELY & GRAHAM, P.C., P O BOX 1871, KNOXVILLE, TN, 37901, US

(21) Appl. No.: 11/945,744

(22) Filed: Nov. 27, 2007

(51) Int. Cl. G09B 19/02

(52) U.S. Cl. 434/191

(57) ABSTRACT

A method for teaching mathematics that includes presenting one or more mnemonic tools that are non-arbitrarily associated with a module or “chunk” of information that covers a particular mathematics concept.

### FIELD

This invention relates to the field of teaching methods. More particularly, this invention relates to a method for teaching mathematics at different learning levels using mnemonic tools.

### BACKGROUND

As of the turn of the century, modern teaching methods related to mathematics have been under close scrutiny because of an apparent general failure in the United States to give students the basic comprehensive building blocks for recall and application in areas such as, for example, addition, subtraction, multiplication, and division. By order of U.S. President George W. Bush dated Apr. 18, 2006, The National Mathematics Advisory Panel was formed under the U.S. Department of Education for the purpose of advising the President on the best use of scientifically based research on the teaching and learning of mathematics. At a Sep. 13, 2006, meeting of the National Mathematics Advisory Panel in Cambridge, Mass., committee member Dr. Tom Loveless, when directing a question to the panel and ex officio members, asked the following: “Can you give us an example of a K-8 math program with a positive impact? The federal government spent a lot of money in that area.” Sep. 13, 2006, Proceedings of The National Mathematics Advisory Panel, U.S. Department of Education, page 79, lines 1-4. Tom Luce, an ex officio member of the panel, responded as follows: “No, sir. It pains me to say that, but the answer is no.” Sep. 13, 2006 Proceedings of The National Mathematics Advisory Panel, U.S. Department of Education, page 79, lines 5-6.

In addition to the apparent conclusion reached on Sep. 13, 2006, regarding popular mathematics teaching methods in the U.S., the National Mathematics Advisory Panel Studies (as well as a number of other sources) have also determined that new or difficult concepts are often best learned in small modules or “chunks” of information.

With mathematics and some other subjects, however, recalling information is only a first step. After information from a module is recalled, the information must be applied in an appropriate form or language. The material associated with a module represents the content to be applied (i.e., the “what”) and the way the material is applied represents the pedagogy (i.e., the “how”).

Teaching both conventional and alternative mathematical algorithms and how to apply such algorithms is important to the learning process that leads to mastering basic mathematics in its various forms. An efficient recall of such algorithms becomes even more critical to the success of students in more advanced subjects such as, for example, physics, chemistry, and biology which require students to develop more complex algorithms based on prior knowledge. These more complex algorithms involve mathematics subjects such as algebra, geometry, trigonometry, and calculus.

What is needed, therefore, is a method for teaching or otherwise presenting mathematics in modules using mnemonic devices that are associated with both the content and the pedagogy of one or more mathematic concept.

### SUMMARY

The above and other needs are met by a method for teaching mathematics using mnemonic tools. A preferred embodiment of the method includes the step of presenting a first mnemonic tool for the purpose of teaching a first mathematic concept, wherein the first mathematic concept is non-arbitrarily associated with the first mnemonic tool, and wherein the first mnemonic tool is non-arbitrarily associated with a set of at least eight equations, the set of equations selected from one of the following groups of equations:

2+2=4, 2+3=5, 2+4=6, 2+5=7, 2+6=8, 2+7=9, 2+8=10, and 2+9=11; a(1)

4−2=2, 5−2=3, 6−2=4, 7−2=5, 8−2=6, 9−2=7, 10−2=8, and 11−2=9; b(1)

2×2=4, 3×2=6, 4×2=8, 5×2=10, 6×2=12, 7×2=14, 8×2=16, and 9×2=18; c(1)

2÷2=1, 4÷2=2, 6÷2=3, 8÷2=4, 10÷2=5, 12÷2=6, 14÷2=7; 16÷2=8, and 18÷2=9; d(1)

9×2=18, 9×3=27, 9×4=36, 9×5=45, 9×6=54, 9×7=63, 9×8=72, and 9×9=81; and e(1)

18÷9=2, 27÷9=3, 36÷9=4, 45÷9=5, 54÷9=6, 63÷9=7, 72÷9=8, and 81÷9=9. f(1)

In a related embodiment, the method described above in paragraph [0007] further includes an additional step including presenting a second mnemonic tool for the purpose of teaching a second mathematic concept, wherein the second mathematic concept is non-arbitrarily associated with the second mnemonic tool, and wherein the second mnemonic tool is non-arbitrarily associated with a set of at least seven equations, the set of equations selected from one of the following groups of equations:

9+3=12, 9+4=13, 9+5=14, 9+6=15, 9+7=16, 9+8=17, and 9+9=18; a(2)

12−9=3, 13−9=4, 14−9=5, 15−9=6, 16−9=7, 17−9=8, and 18−9=9; b(2)

10×2=20, 11×2=22, 12×2=24, 13×2=26, 14×2=28, 20×2=40, and 21×2=42; c(2)

20÷2=10, 22÷2=11, 24÷2=12, 26÷2=13, 28÷2=14, 40÷2=20, and 42÷2=21; d(2)

5×2=10, 5×3=15, 5×4=20, 5×5=25, 5×6=30, 5×7=35, and 5×8=40; and e(2)

10÷5=2, 15÷5=3, 20÷5=4, 25÷5=5, 30÷5=6, 35÷5=7, and 40÷5=8, f(2)

wherein the equations defined in a(2) are associated with the equations defined in a(1), wherein the equations defined in b(2) are associated with the equations defined in b(1), wherein the equations defined in c(2) are associated with the equations defined in c(1), wherein the equations defined in d(2) are associated with the equations defined in d(1), wherein the equations defined in e(2) are associated with the equations defined in e(1), and wherein the equations defined in f(2) are associated with the equations defined in f(1).

In a related embodiment, the method described above in paragraph [0008] further includes an additional step including presenting a third mnemonic tool for the purpose of teaching a third mathematic concept, wherein the third mathematic concept is non-arbitrarily associated with the third mnemonic tool, and wherein the third mnemonic tool is non-arbitrarily associated with a set of at least six equations, the set of equations selected from one of the following groups of equations:

8+3=11, 8+4=12, 8+5=13, 8+6=14, 8+7=15, and 8+8=16; a(3)

11−8=3, 12−8=4, 13−8=5, 14−8=6, 15−8=7, and 16−8=8; b(3)

15×2=(10×2)+(5×2)=30, 16×2=(10×2)+(6×2)=32, 17×2=(10×2)+(7×2)=34, 18×2=(10×2)+(8×2)=36, 19×2=(10×2)+(9×2)=38, and 25×2=(20×2)+(5×2)=50; c(3)

30÷2=(20÷2)+(10÷2)=15, 32÷2=(20÷2)+(12÷2)=16, 34÷2=(20÷2)+(14÷2)=17, 36÷2=(20÷2)+(16÷2)=18, 38÷2=(20÷2)+(18÷2)=19, and 50÷2=(40÷2)+(10÷2)=25; d(3)

3×2=6, 6×2=12, 3×3=9, 3×6=18, 6×6=36, 3×4=12, 6×4=24, 3×8=24, 6×8=48, 3×7=21, and 6×7=42; and e(3)

6÷3=2, 12÷6=2, 9÷3=3, 18÷3=6, 36÷6=6, 12÷3=4, 24÷6=4, 24÷3=8, 48÷6=8, 21÷3=7, and 42÷6=7, f(3)

wherein the equations defined in a(3) are associated with the equations defined in a(2), wherein the equations defined in b(3) are associated with the equations defined in b(2), wherein the equations defined in c(3) are associated with the equations defined in c(2), wherein the equations defined in d(3) are associated with the equations defined in d(2), wherein the equations defined in e(3) are associated with the equations defined in e(2), and wherein the equations defined in f(3) are associated with the equations defined in f(2).

In a related embodiment, the method described above in paragraph [0009] further includes an additional step including presenting a fourth mnemonic tool for the purpose of teaching a fourth mathematic concept, wherein the fourth mathematic concept is non-arbitrarily associated with the fourth mnemonic tool, and wherein the fourth mnemonic tool is non-arbitrarily associated with a set of at least five equations, the set of equations selected from the group consisting of:

3+3=6, 4+4=8, 5+5=10, 6+6=12, and 7+7=14; a(4)

6−3=3, 8−4=4, 10−5=5, 12−6=6, and 14−7=7; b(4)

2×2=4, 4×2=8, 4×4=16, 4×8=32, 8×2=16, 8×8=64, 2×7=14, 4×7=28, and 8×7=56; and c(4)

4÷2=2, 8÷4=2, 16÷4=4, 32÷4=8, 16÷8=2, 32÷8=4, 64÷8=8, 14÷2=7, 28÷4=7, and 56÷8=7, d(4)

wherein the equations defined in a(4) are associated with the equations defined in a(3), wherein the equations defined in b(4) are associated with the equations defined in b(3), wherein the equations defined in c(4) are associated with the equations defined in e(3), and wherein the equations defined in d(4) are associated with the equations defined in f(3).

In a related embodiment, the method described above in paragraph [0010] further includes an additional step including presenting a fifth mnemonic tool for the purpose of teaching a fifth mathematic concept, wherein the fifth mathematic concept is non-arbitrarily associated with the fifth mnemonic tool, and wherein the fifth mnemonic tool is non-arbitrarily associated with a set of at least four equations, the set of equations selected from one of the following groups of equations:

3+4=7, 4+5=9, 5+6=11, and 6+7=13; and a(5)

7−3=4, 9−4=5, 11−5=6, and 13−6=7, b(5)

wherein the equations defined in a(5) are associated with the equations defined in a(4), and wherein the equations defined in b(5) are associated with the equations defined in b(4).

In a related embodiment, the method described above in paragraph [0011] further includes an additional step including presenting a sixth mnemonic tool for the purpose of teaching a sixth mathematic concept, wherein the sixth mathematic concept is non-arbitrarily associated with the sixth mnemonic tool, and wherein the sixth mnemonic tool is non-arbitrarily associated with a set of at least six equations, the set of equations selected from one of the following groups of equations:

5+3=8, 6+3=9, 6+4=10, 7+3=10, 7+4=11, and 7+5=12; and a(6)

8−5=3, 9−6=3, 10−6=4, 10−7=3, 11−7=4, and 12−7=5, b(6)

wherein the equations defined in a(6) are associated with the equations defined in a(5), and wherein the equations defined in b(6) are associated with the equations defined in b(5).

In a related embodiment, the method described above in paragraph [0012] further includes an additional step including presenting a seventh mnemonic tool for the purpose of teaching a seventh mathematic concept, wherein the seventh mathematic concept is non-arbitrarily associated with the seventh mnemonic tool, and wherein the seventh mnemonic tool is non-arbitrarily associated with a set of at least nine equations, the set of equations selected from one of the following groups of equations:

0+1=1, 0+2=2, 0+3=3, 0+4=4, 0+5=5, 0+6=6, 0+7=7, 0+8=8, and 0+9=9; and a(7)

1−0=1, 2−0=2, 3−0=3, 4−0=4, 5−0=5, 6−0=6, 7−0=7, 8−0=8, and 9−0=9, b(7).

wherein the equations defined in a(7) are associated with the equations defined in a(6), and wherein the equations defined in b(7) are associated with the equations defined in b(6).

In a related embodiment, the method described above in paragraph [0013] further includes an additional step including presenting an eighth mnemonic tool for the purpose of teaching an eighth mathematic concept, wherein the eighth mathematic concept is non-arbitrarily associated with the eighth mnemonic tool, and wherein the eighth mnemonic tool is non-arbitrarily associated with a set of at least nine equations, the set of equations selected from one of the following groups of equations:

1+1=2, 1+2=3, 1+3=4, 1+4=5, 1+5=6, 1+6=7, 1+7=8, 1+8=9, and 1+9=10; and a(8)

1−1=0, 2−1=1, 3−1=2, 4−1=3, 5−1=4, 6−1=5, 7−1=6, 8−1=7, 9−1=8, and 10−1=9, b(8).

wherein the equations defined in a(8) are associated with the equations defined in a(7), and wherein the equations defined in b(8) are associated with the equations defined in b(7).

In another embodiment, the third mnemonic tool described above in paragraph [0009] is non-arbitrarily associated with a set of at least six equations, the set of equations selected from one of the following groups of equations:

15×2=(10×2)+(5×2)=30, 16×2=(10×2)+(6×2)=32, 17×2=(10×2)+(7×2)=34, 18×2=(10×2)+(8×2)=36, 19×2=(10×2)+(9×2)=38, and 25×2=(20×2)+(5×2)=50; and c(3).

30÷2=(20÷2)+(10÷2)=15, 32÷2=(20÷2)+(12÷2)=16, 34÷2=(20÷2)+(14÷2)=17, 36÷2=(20÷2)+(16÷2)=18, 38÷2=(20÷2)+(18÷8+2)=19, and 50÷2=(40÷2)+(10÷2)=25, d(3).

and wherein the method includes a step of providing an exercise for the purpose of teaching a student to associate the first mnemonic tool with the first mathematic concept, to associate the second mnemonic tool with the second mathematic concept, and to associate the third mnemonic tool with the third mathematic concept.

In a related embodiment, the fourth mnemonic tool described above in paragraph [0010] is non-arbitrarily associated with a set of at least nine equations, the set of equations selected from one of the following groups of equations:

2×2=4, 4×2=8, 4×4=16, 4×8=32, 8×2=16, 8×8=64, 2×7=14, 4×7=28, and 8×7=56; and c(4)

4÷2=2, 8÷4=2, 16÷4=4, 32÷4=8, 16÷8=2, 32÷8=4, 64÷8=8, 14÷2=7, 28÷4=7, and 56 8=7, d(4)

and wherein the method includes a step of providing an exercise for the purpose of teaching a person to associate the first mnemonic tool with the first mathematic concept, to associate the second mnemonic tool with the second mathematic concept, to associate the third mnemonic tool with the third mathematic concept, and to associate the fourth mnemonic tool with the fourth mathematic concept.

In a related embodiment, the method described above in paragraph [0014] further includes a step of providing an exercise for the purpose of teaching a person to associate the first mnemonic tool with the first mathematic concept, to associate the second mnemonic tool with the second mathematic concept, to associate the third mnemonic tool with the third mathematic concept, to associate the fourth mnemonic tool with the fourth mathematic concept, to associate the fifth mnemonic tool with the fifth mathematic concept, to associate the sixth mnemonic tool with the sixth mathematic concept, to associate the seventh mnemonic tool with the seventh mathematic concept, and to associate the eighth mnemonic tool with the eighth mathematic concept.

In a related embodiment, the method described above in paragraph [0017] further includes the steps of:
A. presenting the first mnemonic tool for the purpose of teaching a ninth mathematic concept, wherein the ninth mathematic concept is non-arbitrarily associated with the first mnemonic tool, and wherein the first mnemonic tool is non-arbitrarily associated with a set of at least eight equations including 4−2=2, 5−2=3, 6−2=4, 7−2=5, 8−2=6, 9−2=7, 10−2=8, and 11−2=9;
B. presenting the second mnemonic tool for the purpose of teaching a tenth mathematic concept, wherein the tenth mathematic concept is non-arbitrarily associated with the second mnemonic tool, and wherein the second mnemonic tool is non-arbitrarily associated with a set of at least seven equations including 12−9=3, 13−9=4, 14−9=5, 15−9=6, 16−9=7, 17−9=8, and 18−9=9;
C. presenting the third mnemonic tool for the purpose of teaching an eleventh mathematic concept, wherein the eleventh mathematic concept is non-arbitrarily associated with the third mnemonic tool, and wherein the third mnemonic tool is non-arbitrarily associated with a set of at least six equations including 11−8=3, 12−8=4, 13−8=5, 14−8=6, 15−8=7, and 16−8=8;
D. presenting the fourth mnemonic tool for the purpose of teaching a twelfth mathematic concept, wherein the twelfth mathematic concept is non-arbitrarily associated with the fourth mnemonic tool, and wherein the fourth mnemonic tool is non-arbitrarily associated with a set of at least five equations including 6−3=3, 8−4=4, 10−5=5, 12−6=6, and 14−7=7;
E. presenting the fifth mnemonic tool for the purpose of teaching a thirteenth mathematic concept, wherein the thirteenth mathematic concept is non-arbitrarily associated with the fifth mnemonic tool, and wherein the fifth mnemonic tool is non-arbitrarily associated with a set of at least four equations including 7−3=4, 9−4=5, 11−5=6, and 13−6=7;
F. presenting the sixth mnemonic tool for the purpose of teaching a fourteenth mathematic concept, wherein the fourteenth mathematic concept is non-arbitrarily associated with the sixth mnemonic tool, and wherein the sixth mnemonic tool is non-arbitrarily associated with a set of at least six equations including 8−5=3, 9−6=3, 10−6=4, 10−7=3, 11−7=4, and 12−7=5;
G. presenting the seventh mnemonic tool for the purpose of teaching a fifteenth mathematic concept, wherein the fifteenth mathematic concept is non-arbitrarily associated with the seventh mnemonic tool, and wherein the seventh mnemonic tool is non-arbitrarily associated with a set of at least nine equations including 1−0=1, 2−0=2, 3−0=3, 4−0=4, 5−0=5, 6−0=6, 7−0=7, 8−0=8, and 9−0=9;
H. presenting the eighth mnemonic tool for the purpose of teaching a sixteenth mathematic concept, wherein the sixteenth mathematic concept is non-arbitrarily associated with the eighth mnemonic tool, and wherein the eighth mnemonic tool is non-arbitrarily associated with a set of at least nine equations including −1=0, 2−1=1, 3−1=2, 4−1=3, 5−1=4, 6−1=5, 7−1=6, 8−1=7, 9−1=8, and 10−1=9; and
I. providing an exercise for the purpose of teaching a person to associate the first mnemonic tool with the ninth mathematic concept, to associate the second mnemonic tool with the tenth mathematic concept, to associate the third mnemonic tool with the eleventh mathematic concept, to associate the fourth mnemonic tool with the twelfth mathematic concept, to associate the fifth mnemonic tool with the thirteenth mathematic concept, to associate the sixth mnemonic tool with the fourteenth mathematic concept, to associate the seventh mnemonic tool with the fifteenth mathematic concept, and to associate the eighth mnemonic tool with the sixteenth mathematic concept.

In a related embodiment, the method described above in paragraph [0017] further includes the consecutive steps of:
A. presenting a ninth mnemonic tool for the purpose of teaching a ninth mathematic concept, wherein the ninth mathematic concept is non-arbitrarily associated with the ninth mnemonic tool, and wherein the ninth mnemonic tool is non-arbitrarily associated with a set of at least eight equations including 4−2=2, 5−2=3, 6−2=4, 7−2=5, 8−2=6, 9−2=7, 10−2=8, and 11−2=9;
B. presenting a tenth mnemonic tool for the purpose of teaching a tenth mathematic concept, wherein the tenth mathematic concept is non-arbitrarily associated with the tenth mnemonic tool, and wherein the tenth mnemonic tool is non-arbitrarily associated with a set of at least seven equations including 12−9=3, 13−9=4, 14−9=5, 15−9=6, 16−9=7, 17−9=8, and 18−9=9;
C. presenting an eleventh mnemonic tool for the purpose of teaching an eleventh mathematic concept, wherein the eleventh mathematic concept is non-arbitrarily associated with the eleventh mnemonic tool, and wherein the eleventh mnemonic tool is non-arbitrarily associated with a set of at least six equations including 11−8=3, 12−8=4, 13−8=5, 14−8=6, 15−8=7, and 16−8=8;
D. presenting a twelfth mnemonic tool for the purpose of teaching a twelfth mathematic concept, wherein the twelfth mathematic concept is non-arbitrarily associated with the twelfth mnemonic tool, and wherein the twelfth mnemonic tool is non-arbitrarily associated with a set of at least five equations including 6−3=3, 8−4=4, 10−5=5, 12−6=6, and 14−7=7;
E. presenting a thirteenth mnemonic tool for the purpose of teaching a thirteenth mathematic concept, wherein the thirteenth mathematic concept is non-arbitrarily associated with the thirteenth mnemonic tool, and wherein the thirteenth mnemonic tool is non-arbitrarily associated with a set of at least four equations including 7−3=4, 9−4=5, 11−5=6, and 13−6=7;
F. presenting a fourteenth mnemonic tool for the purpose of teaching a fourteenth mathematic concept, wherein the fourteenth mathematic concept is non-arbitrarily associated with the fourteenth mnemonic tool, and wherein the fourteenth mnemonic tool is non-arbitrarily associated with a set of at least six equations including 8−5=3, 9−6=3, 10−6=4, 10−7=3, 11−7=4, and 12−7=5;
G. presenting a fifteenth mnemonic tool for the purpose of teaching a fifteenth mathematic concept, wherein the fifteenth mathematic concept is non-arbitrarily associated with the fifteenth mnemonic tool, and wherein the fifteenth mnemonic tool is non-arbitrarily associated with a set of at least nine equations including 1−0=1, 2−0=2, 3−0=3, 4−0=4, 5−0=5, 6−0=6, 7−0=7, 8−0=8, and 9−0=9;
H. presenting a sixteenth mnemonic tool for the purpose of teaching a sixteenth mathematic concept, wherein the sixteenth mathematic concept is non-arbitrarily associated with the sixteenth mnemonic tool, and wherein the sixteenth mnemonic tool is non-arbitrarily associated with a set of at least nine equations including −1=0, 2−1=1, 3−1=2, 4−1=3, 5−1=4, 6−1=5, 7−1=6, 8−1=7, 9−1=8, and 10−1=9; and
I. providing an exercise for the purpose of teaching a person to associate the ninth mnemonic tool with the ninth mathematic concept, to associate the tenth mnemonic tool with the tenth mathematic concept, to associate the eleventh mnemonic tool with the eleventh mathematic concept, to associate the twelfth mnemonic tool with the twelfth mathematic concept, to associate the thirteenth mnemonic tool with the thirteenth mathematic concept, to associate the fourteenth mnemonic tool with the fourteenth mathematic concept, to associate the fifteenth mnemonic tool with the fifteenth mathematic concept, and to associate the sixteenth mnemonic tool with the sixteenth mathematic concept.

In a related embodiment, the method described above in paragraph [0018] further includes the steps of:
A. presenting a seventeenth mnemonic tool for the purpose of teaching a seventeenth mathematic concept, wherein the seventeenth mathematic concept is non-arbitrarily associated with the seventeenth mnemonic tool, and wherein the seventeenth mnemonic tool is non-arbitrarily associated with a set of at least eight equations including 2×2=4, 3×2=6, 4×2=8, 5×2=10, 6×2=12, 7×2=14, 8×2=16, and 9×2=18;
B. presenting an eighteenth mnemonic tool for the purpose of teaching an eighteenth mathematic concept, wherein the eighteenth mathematic concept is non-arbitrarily associated with the eighteenth mnemonic tool, and wherein the eighteenth mnemonic tool is non-arbitrarily associated with a set of at least seven equations including 10×2=20, 11×2=22, 12×2=24, 13×2=26, 14×2=28, 20×2=40, and 21×2=42;
C. presenting a nineteenth mnemonic tool for the purpose of teaching a nineteenth mathematic concept, wherein the nineteenth mathematic concept is non-arbitrarily associated with the nineteenth mnemonic tool, and wherein the nineteenth mnemonic tool is non-arbitrarily associated with a set of at least six equations including 15×2=(10×2)+(5×2)=30, 16×2=(10×2)+(6×2)=32, 17×2=(10×2)+(7×2)=34, 18×2=(10×2)+(8×2)=36, 19×2=(10×2)+(9×2)=38, and 25×2=(20×2)+(5×2)=50; and
D. providing an exercise for the purpose of teaching a person to associate the seventeenth mnemonic tool with the seventeenth mathematic concept, to associate the eighteenth mnemonic tool with the eighteenth mathematic concept, and to associate the nineteenth mnemonic tool with the nineteenth mathematic concept.

In another embodiment, the method described above in paragraph [0020] wherein the seventeenth mnemonic tool includes a mnemonic tool that is substantially identical to the fourth mnemonic tool.

In another embodiment, the method described above in paragraph [0019] further includes the steps of:
A. presenting a seventeenth mnemonic tool for the purpose of teaching a seventeenth mathematic concept, wherein the seventeenth mathematic concept is non-arbitrarily associated with the seventeenth mnemonic tool, and wherein the seventeenth mnemonic tool is non-arbitrarily associated with a set of at least eight equations including 2×2=4, 3×2=6, 4×2=8, 5×2=10, 6×2=12, 7×2=14, 8×2=16, and 9×2=18;
B. presenting an eighteenth mnemonic tool for the purpose of teaching an eighteenth mathematic concept, wherein the eighteenth mathematic concept is non-arbitrarily associated with the eighteenth mnemonic tool, and wherein the eighteenth mnemonic tool is non-arbitrarily associated with a set of at least seven equations including 10×2=20, 11×2=22, 12×2=24, 13×2=26, 14×2=28, 20×2=40, and 21×2=42;
C. presenting a nineteenth mnemonic tool for the purpose of teaching a nineteenth mathematic concept, wherein the nineteenth mathematic concept is non-arbitrarily associated with the nineteenth mnemonic tool, and wherein the nineteenth mnemonic tool is non-arbitrarily associated with a set of at least six equations including 15×2=(10×2)+(5×2)=30, 16×2=(10×2)+(6×2)=32, 17×2=(10×2)+(7×2)=34, 18×2=(10×2)+(8×2)=36, 19×2=(10×2)+(9×2)=38, and 25×2=(20×2)+(5×2)=50; and
D. providing an exercise for the purpose of teaching a person to associate the seventeenth mnemonic tool with the seventeenth mathematic concept, to associate the eighteenth mnemonic tool with the eighteenth mathematic concept, and to associate the nineteenth mnemonic tool with the nineteenth mathematic concept.

In another embodiment, the method described above in paragraph [0019] further includes the steps of:
A. presenting a twentieth mnemonic tool for the purpose of teaching a twentieth mathematic concept, wherein the twentieth mathematic concept is non-arbitrarily associated with the twentieth mnemonic tool, and wherein the twentieth mnemonic tool is non-arbitrarily associated with a set of at least eight equations including 2÷2=1, 4÷2=2, 6÷2=3, 8÷2=4, 10÷2=5, 12÷2=6, 14÷2=7; 16÷2=8, and 18÷2=9;
B. presenting a twenty-first mnemonic tool for the purpose of teaching a twenty-first mathematic concept, wherein the twenty-first mathematic concept is non-arbitrarily associated with the twenty-first mnemonic tool, and wherein the twenty-first mnemonic tool is non-arbitrarily associated with a set of at least seven equations including 20÷2=10, 22÷2=11, 24÷2=12, 26÷2=13, 28÷2=14, 40÷2=20, and 42÷2=21;
C. presenting a twenty-second mnemonic tool for the purpose of teaching a twenty-second mathematic concept, wherein the twenty-second mathematic concept is non-arbitrarily associated with the twenty-second mnemonic tool, and wherein the twenty-second mnemonic tool is non-arbitrarily associated with a set of at least six equations including 30÷2=(20÷2)+(10÷2)=15, 32÷2=(20÷2)+(12÷2+2)=16, 34÷2=(20÷2)+(14÷4+2)=17, 36÷2=(20÷2)+(16÷6+2)=18, 38÷2=(20÷2)+(18÷8+2)=19, and 50÷2=(40÷2)+(10÷2)=25; and
D. providing an exercise for the purpose of teaching a person to associate the twentieth mnemonic tool with the twentieth mathematic concept, to associate the twenty-first mnemonic tool with the twenty-first mathematic concept, and to associate the twenty-second mnemonic tool with the twenty-second mathematic concept.

In another embodiment, the method described above in paragraph [0020] further includes the steps of:
A. presenting a twentieth mnemonic tool for the purpose of teaching a twentieth mathematic concept, wherein the twentieth mathematic concept is non-arbitrarily associated with the twentieth mnemonic tool, and wherein the twentieth mnemonic tool is non-arbitrarily associated with a set of at least eight equations including 2÷2=1, 4÷2=2, 6÷2=3, 8÷2=4, 10÷2=5, 12÷2=6, 14÷2=7; 16÷2=8, and 18÷2=9;
B. presenting a twenty-first mnemonic tool for the purpose of teaching a twenty-first mathematic concept, wherein the twenty-first mathematic concept is non-arbitrarily associated with the twenty-first mnemonic tool, and wherein the twenty-first mnemonic tool is non-arbitrarily associated with a set of at least seven equations including 20÷2=10, 22÷2=11, 24÷2=12, 26÷2=13, 28÷2=14, 40÷2=20, and 42÷2=21;
C. presenting a twenty-second mnemonic tool for the purpose of teaching a twenty-second mathematic concept, wherein the twenty-second mathematic concept is non-arbitrarily associated with the twenty-second mnemonic tool, and wherein the twenty-second mnemonic tool is non-arbitrarily associated with a set of at least six equations including 30÷2=(20÷2)+(10÷2)=15, 32÷2=(20÷2)+(12÷2)=16, 34÷2=(20÷2)+(14÷4+2)=17, 36÷2=(20÷2)+(16÷6+2)=18, 38÷2=(20÷2)+(18÷+2)=19, and 50÷2=(40÷2)+(10÷2)=25; and
D. providing an exercise for the purpose of teaching a person to associate the twentieth mnemonic tool with the twentieth mathematic concept, to associate the twenty-first mnemonic tool with the twenty-first mathematic concept, and to associate the twenty-second mnemonic tool with the twenty-second mathematic concept.

In another embodiment, the method described above in paragraph [0018] further includes the steps of:
A. presenting a twenty-third mnemonic tool for the purpose of teaching a twenty-third mathematic concept, wherein the twenty-third mathematic concept is non-arbitrarily associated with the twenty-third mnemonic tool, and wherein the twenty-third mnemonic tool is non-arbitrarily associated with a set of at least eight equations including 9×2=18, 9×3=27, 9×4=36, 9×5=45, 9×6=54, 9×7=63, 9×8=72, and 9×9=81;
B. presenting a twenty-fourth mnemonic tool for the purpose of teaching a twenty-fourth mathematic concept, wherein the twenty-fourth mathematic concept is non-arbitrarily associated with the twenty-fourth mnemonic tool, and wherein the twenty-fourth mnemonic tool is non-arbitrarily associated with a set of at least seven equations including 5×2=10, 5×3=15, 5×4=20, 5×5=25, 5×6=30, 5×7=35, and 5×8=40;
C. presenting a twenty-fifth mnemonic tool for the purpose of teaching a twenty-fifth mathematic concept, wherein the twenty-fifth mathematic concept is non-arbitrarily associated with the twenty-fifth mnemonic tool, and wherein the twenty-fifth mnemonic tool is non-arbitrarily associated with a set of at least six equations including 3×2=6, 6×2=12, 3×3=9, 3×6=18, 6×6=36, 3×4=12, 6×4=24, 3×8=24, 6×8=48, 3×7=21, and 6×7=42;
D. presenting a twenty-sixth mnemonic tool for the purpose of teaching a twenty-sixth mathematic concept, wherein the twenty-sixth mathematic concept is non-arbitrarily associated with the twenty-sixth mnemonic tool, and wherein the twenty-sixth mnemonic tool is non-arbitrarily associated with a set of at least nine equations including 2×2=4, 4×2=8, 4×4=16, 4×8=32, 8×2=16, 8×8=64, 2×7=14, 4×7=28, and 8×7=56; and
E. providing an exercise for the purpose of teaching a person to associate the twenty-third mnemonic tool with the twenty-third mathematic concept, to associate the twenty-fourth mnemonic tool with the twenty-fourth mathematic concept, to associate the twenty-fifth mnemonic tool with the twenty-fifth mathematic concept, and to associate the twenty-sixth mnemonic tool with the twenty-sixth mathematic concept.

In another embodiment, the method described above in paragraph [0019] further includes the steps of:
A. presenting a twenty-third mnemonic tool for the purpose of teaching a twenty-third mathematic concept, wherein the twenty-third mathematic concept is non-arbitrarily associated with the twenty-third mnemonic tool, and wherein the twenty-third mnemonic tool is non-arbitrarily associated with a set of at least eight equations including 9×2=18, 9×3=27, 9×4=36, 9×5=45, 9×6=54, 9×7=63, 9×8=72, and 9×9=81;
B. presenting a twenty-fourth mnemonic tool for the purpose of teaching a twenty-fourth mathematic concept, wherein the twenty-fourth mathematic concept is non-arbitrarily associated with the twenty-fourth mnemonic tool, and wherein the twenty-fourth mnemonic tool is non-arbitrarily associated with a set of at least seven equations including 5×2=10, 5×3=15, 5×4=20, 5×5=25, 5×6=30, 5×7=35, and 5×8=40;
C. presenting a twenty-fifth mnemonic tool for the purpose of teaching a twenty-fifth mathematic concept, wherein the twenty-fifth mathematic concept is non-arbitrarily associated with the twenty-fifth mnemonic tool, and wherein the twenty-fifth mnemonic tool is non-arbitrarily associated with a set of at least six equations including 3×2=6, 6×2=12, 3×3=9, 3×6=18, 6×6=36, 3×4=12, 6×4=24, 3×8=24, 6×8=48, 3×7=21, and 6×7=42;
D. presenting a twenty-sixth mnemonic tool for the purpose of teaching a twenty-sixth mathematic concept, wherein the twenty-sixth mathematic concept is non-arbitrarily associated with the twenty-sixth mnemonic tool, and wherein the twenty-sixth mnemonic tool is non-arbitrarily associated with a set of at least nine equations including 2×2=4, 4×2=8, 4×4=16, 4×8=32, 8×2=16, 8×8=64, 2×7=14, 4×7=28, and 8×7=56; and
E. providing an exercise for the purpose of teaching a person to associate the twenty-third mnemonic tool with the twenty-third mathematic concept, to associate the twenty-fourth mnemonic tool with the twenty-fourth mathematic concept, to associate the twenty-fifth mnemonic tool with the twenty-fifth mathematic concept, and to associate the twenty-sixth mnemonic tool with the twenty-sixth mathematic concept.

In another embodiment, the method described above in paragraph [0025] further includes the steps of:
A. presenting the twenty-third mnemonic tool for the purpose of teaching a twenty-seventh mathematic concept, wherein the twenty-seventh mathematic concept is non-arbitrarily associated with the twenty-third mnemonic tool, and wherein the twenty-third mnemonic tool is non-arbitrarily associated with a set of at least eight equations including 18÷9=2, 27÷9=3, 36÷9=4, 45÷9=5, 54÷9=6, 63÷9=7, 72÷9=8, and 81÷9=9;
B. presenting the twenty-fourth mnemonic tool for the purpose of teaching a twenty-eighth mathematic concept, wherein the twenty-eighth mathematic concept is non-arbitrarily associated with the twenty-fourth mnemonic tool, and wherein the twenty-fourth mnemonic tool is non-arbitrarily associated with a set of at least seven equations including 10÷5=2, 15÷5=3, 20÷5=4, 25÷5=5, 30÷5=6, 35÷5=7, and 40÷5=8;
C. presenting the twenty-fifth mnemonic tool for the purpose of teaching a twenty-ninth mathematic concept, wherein the twenty-ninth mathematic concept is non-arbitrarily associated with the twenty-fifth mnemonic tool, and wherein the twenty-fifth mnemonic tool is non-arbitrarily associated with a set of at least eleven equations including 6÷3=2, 12÷6=2, 9÷3=3, 18÷3=6, 36÷6=6, 12÷3=4, 24÷6=4, 24÷3=8, 48÷6=8, 21÷3=7, and 42÷6=7;
D. presenting the twenty-sixth mnemonic tool for the purpose of teaching a thirtieth mathematic concept, wherein the thirtieth mathematic concept is non-arbitrarily associated with the twenty-sixth mnemonic tool, and wherein the twenty-sixth mnemonic tool is non-arbitrarily associated with a set of at least ten equations including 4÷2=2, 8÷4=2, 16÷4=4, 32÷4=8, 16÷8=2, 32÷8=4, 64÷8=8, 14÷2=7, 28÷4=7, and 56÷8=7; and
E. providing an exercise for the purpose of teaching a person to associate the twenty-third mnemonic tool with the twenty-seventh mathematic concept, to associate the twenty-fourth mnemonic tool with the twenty-eighth mathematic concept, to associate the twenty-fifth mnemonic tool with the twenty-ninth mathematic concept, and to associate the twenty-sixth mnemonic tool with the thirtieth mathematic concept.

In another embodiment, the method described above in paragraph [0025] further includes the steps of:
A. presenting a twenty-seventh mnemonic tool for the purpose of teaching a twenty-seventh mathematic concept, wherein the twenty-seventh mathematic concept is non-arbitrarily associated with the twenty-seventh mnemonic tool, and wherein the twenty-seventh mnemonic tool is non-arbitrarily associated with a set of at least eight equations including 18÷9=2, 27÷9=3, 36÷9=4, 45÷9=5, 54÷9=6, 63÷9=7, 72÷9=8, and 81÷9=9;
B. presenting a twenty-eighth mnemonic tool for the purpose of teaching a twenty-eighth mathematic concept, wherein the twenty-eighth mathematic concept is non-arbitrarily associated with the twenty-eighth mnemonic tool, and wherein the twenty-eighth mnemonic tool is non-arbitrarily associated with a set of at least seven equations including 10÷5=2, 15÷5=3, 20÷5=4, 25÷5=5, 30÷5=6, 35÷5=7, and 40÷5=8;
C. presenting a twenty-ninth mnemonic tool for the purpose of teaching a twenty-ninth mathematic concept, wherein the twenty-ninth mathematic concept is non-arbitrarily associated with the twenty-ninth mnemonic tool, and wherein the twenty-ninth mnemonic tool is non-arbitrarily associated with a set of at least eleven equations including 6÷3=2, 12÷6=2, 9÷3=3, 18÷3=6, 36÷6=6, 12÷3=4, 24÷6=4, 24÷3=8, 48÷6=8, 21÷3=7, and 42÷6=7;
D. presenting a thirtieth mnemonic tool for the purpose of teaching a thirtieth mathematic concept, wherein the thirtieth mathematic concept is non-arbitrarily associated with the thirtieth mnemonic tool, and wherein the thirtieth mnemonic tool is non-arbitrarily associated with a set of at least ten equations including 4÷2=2, 8÷4=2, 16÷4=4, 32÷4=8, 16÷8=2, 32÷8=4, 64÷8=8, 14÷2=7, 28÷4=7, and 56÷8=7; and
E. providing an exercise for the purpose of teaching a person to associate the twenty-seventh mnemonic tool with the twenty-seventh mathematic concept, to associate the twenty-eighth mnemonic tool with the twenty-eighth mathematic concept, to associate the twenty-ninth mnemonic tool with the twenty-ninth mathematic concept, and to associate the thirtieth mnemonic tool with the thirtieth mathematic concept.

In another embodiment, the method described above in paragraph [0026] further includes the steps of:
A. presenting the twenty-third mnemonic tool for the purpose of teaching a twenty-seventh mathematic concept, wherein the twenty-seventh mathematic concept is non-arbitrarily associated with the twenty-third mnemonic tool, and wherein the twenty-third mnemonic tool is non-arbitrarily associated with a set of at least eight equations including 18÷9=2, 27÷9=3, 36÷9=4, 45÷9=5, 54÷9=6, 63÷9=7, 72÷9=8, and 81÷9=9;
B. presenting the twenty-fourth mnemonic tool for the purpose of teaching a twenty-eighth mathematic concept, wherein the twenty-eighth mathematic concept is non-arbitrarily associated with the twenty-fourth mnemonic tool, and wherein the twenty-fourth mnemonic tool is non-arbitrarily associated with a set of at least seven equations including 10÷5=2, 15÷5=3, 20÷5=4, 25÷5=5, 30÷5=6, 35÷5=7, and 40÷5=8;
C. presenting the twenty-fifth mnemonic tool for the purpose of teaching a twenty-ninth mathematic concept, wherein the twenty-ninth mathematic concept is non-arbitrarily associated with the twenty-fifth mnemonic tool, and wherein the twenty-fifth mnemonic tool is non-arbitrarily associated with a set of at least eleven equations including 6÷3=2, 12÷6=2, 9÷3=3, 18÷3=6, 36÷6=6, 12÷3=4, 24÷6=4, 24÷3=8, 48÷6=8, 21÷3=7, and 42÷6=7;
D. presenting the twenty-sixth mnemonic tool for the purpose of teaching a thirtieth mathematic concept, wherein the thirtieth mathematic concept is non-arbitrarily associated with the twenty-sixth mnemonic tool, and wherein the twenty-sixth mnemonic tool is non-arbitrarily associated with a set of at least ten equations including 4÷2=2, 8÷4=2, 16÷4=4, 32÷4=8, 16÷8=2, 32÷8=4, 64÷8=8, 14÷2=7, 28÷4=7, and 56÷8=7; and
E. providing an exercise for the purpose of teaching a person to associate the twenty-third mnemonic tool with the twenty-seventh mathematic concept, to associate the twenty-fourth mnemonic tool with the twenty-eighth mathematic concept, to associate the twenty-fifth mnemonic tool with the twenty-ninth mathematic concept, and to associate the twenty-sixth mnemonic tool with the thirtieth mathematic concept.

In another embodiment, the method described above in paragraph [0026] further includes the steps of:
A. presenting a twenty-seventh mnemonic tool for the purpose of teaching a twenty-seventh mathematic concept, wherein the twenty-seventh mathematic concept is non-arbitrarily associated with the twenty-seventh mnemonic tool, and wherein the twenty-seventh mnemonic tool is non-arbitrarily associated with a set of at least eight equations including 18÷9=2, 27÷9=3, 36÷9=4, 45÷9=5, 54÷9=6, 63÷9=7, 72÷9=8, and 81÷9=9;
B. presenting a twenty-eighth mnemonic tool for the purpose of teaching a twenty-eighth mathematic concept, wherein the twenty-eighth mathematic concept is non-arbitrarily associated with the twenty-eighth mnemonic tool, and wherein the twenty-eighth mnemonic tool is non-arbitrarily associated with a set of at least seven equations including 10÷5=2, 15÷5=3, 20÷5=4, 25÷5=5, 30÷5=6, 35÷5=7, and 40÷5=8;
C. presenting a twenty-ninth mnemonic tool for the purpose of teaching a twenty-ninth mathematic concept, wherein the twenty-ninth mathematic concept is non-arbitrarily associated with the twenty-ninth mnemonic tool, and wherein the twenty-ninth mnemonic tool is non-arbitrarily associated with a set of at least eleven equations including 6÷3=2, 12÷6=2, 9÷3=3, 18÷3=6, 36÷6=6, 12÷3=4, 24÷6=4, 24÷3=8, 48÷6=8, 21÷3=7, and 42÷6=7;
D. presenting a thirtieth mnemonic tool for the purpose of teaching a thirtieth mathematic concept, wherein the thirtieth mathematic concept is non-arbitrarily associated with the thirtieth mnemonic tool, and wherein the thirtieth mnemonic tool is non-arbitrarily associated with a set of at least ten equations including 4÷2=2, 8÷4=2, 16÷4=4, 32÷4=8, 16÷8=2, 32÷8=4, 64÷8=8, 14÷2=7, 28÷4=7, and 56÷8=7; and
E. providing an exercise for the purpose of teaching a person to associate the twenty-seventh mnemonic tool with the twenty-seventh mathematic concept, to associate the twenty-eighth mnemonic tool with the twenty-eighth mathematic concept, to associate the twenty-ninth mnemonic tool with the twenty-ninth mathematic concept, and to associate the thirtieth mnemonic tool with the thirtieth mathematic concept.

It is an object of certain embodiments of the present invention to provide a tool to teach students a mathematic concept by presenting an association between at least one mnemonic device that is non-arbitrarily associated with both the mathematic concept and specific examples of the application of the mathematic concept.

It is also an object of certain embodiments of the present invention to teach or otherwise present the application of specific mathematic concepts in small modules or manageable “chunks” of about seven facts.

It is further an object of certain embodiments of the present invention to provide a tool to systematically teach a student a plurality of mathematic concepts by teaching an association between different mnemonic devices that are each independently and non-arbitrarily associated with a specific mathematic concept and specific examples of the application of the mathematic concept, wherein the mathematic concepts are taught in an order of increasing difficulty through time.

These and other objects will become readily apparent to those of ordinary skill in the art after a review of the following disclosure.

### BRIEF DESCRIPTION OF THE DRAWINGS

Further advantages of the invention are apparent by reference to the detailed description in conjunction with the figures, wherein elements are not to scale so as to more clearly show the details, wherein like reference numbers indicate like elements throughout the several views, and wherein:

FIG. 1 shows a group of mnemonic devices in the form of specific icons;

FIG. 2 shows another group of mnemonic devices in the form of specific icons;

FIG. 3 shows another group of mnemonic devices in the form of specific icons;

FIG. 4 shows another group of mnemonic devices in the form of specific icons;

FIGS. 5A-5H demonstrates using a mnemonic device to convey a mathematic concept involving the multiplication of single digit integers by the number 9.

### DETAILED DESCRIPTION

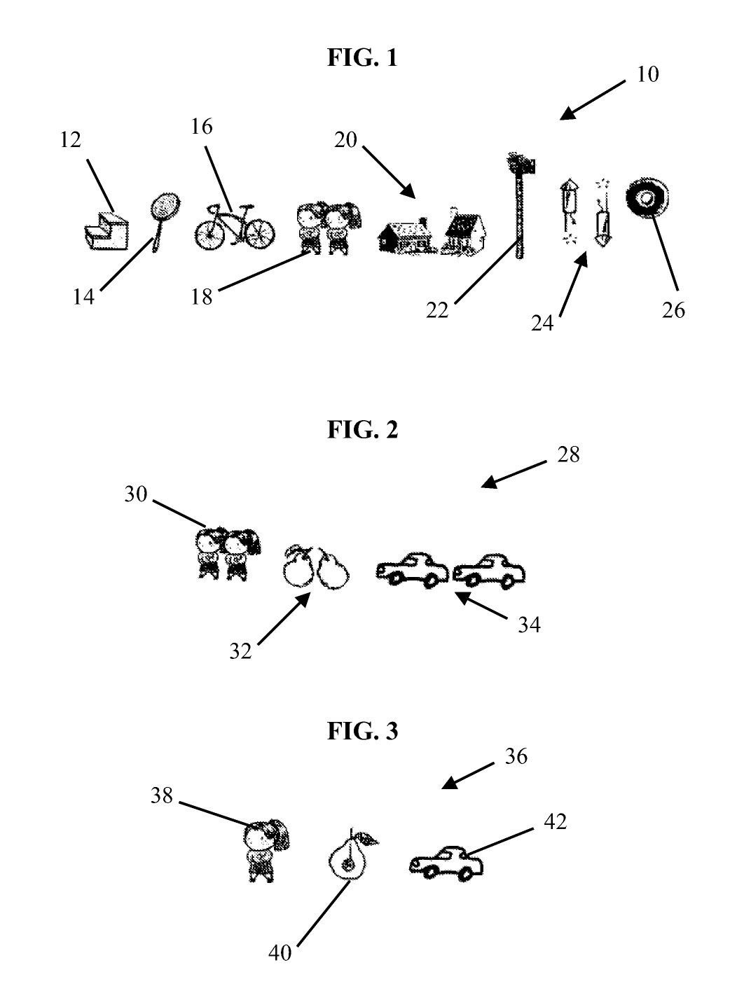

Various embodiments of the invention described herein cover a method for teaching mathematics using mnemonic tools such as, for example, the icons 10 shown in FIG. 1 via a presentation medium. Each mnemonic tool is non-arbitrarily associated with at least one mathematic concept. Additionally, each mnemonic tool is associated with a specific set or “chunk” of related equations. For example, the first icon shown in FIG. 1 is given as a two-step foot ladder 12. The first icon may be taught as a visual representation of adding two units to a base unit (i.e., a first mathematic concept) and/or subtracting two units from a base unit (i.e., a ninth mathematic concept). In this particular embodiment, the first icon is also taught to be associated with a group of preferably about eight equations for addition (Table 1A) and/or a group of preferably about eight equations for subtraction (Table 1B). The groups of equations each represent a limited set of information that a student is encouraged to associate with the application of the first mathematic concept and/or the ninth mathematic concept.

```
TABLE 1A
2 + 2 = 4
2 + 3 = 5
2 + 4 = 6
2 + 5 = 7
2 + 6 = 8
2 + 7 = 9
  2 + 8 = 10
  2 + 9 = 11
```

TABLE 1B
4 − 2 = 2
5 − 2 = 3
6 − 2 = 4
7 − 2 = 5
8 − 2 = 6
9 − 2 = 7
10 − 2 = 8
11 − 2 = 9

The second icon shown in FIG. 1 is given as an image of a lollipop 14. The second icon may be taught as a visual representation of adding nine units to a base unit (i.e., a second mathematic concept) and/or subtracting nine units from a base unit (i.e., a tenth mathematic concept). The association is non-arbitrary at least in part because the second icon (e.g., the lollipop 14) is visually similar to the Arabic numeral 9. In this particular embodiment, the second icon is also taught to be associated with a group of preferably about seven equations for addition (Table 2A) and/or a group of preferably about seven equations for subtraction (Table 2B). The groups of equations each represent a limited set of information that a student is encouraged to associate with the application of the second mathematic concept and/or the tenth mathematic concept.

Any single digit integer added to a nine will result in the answer (or sum) being a number in the teens. Thus, the sum is two digits, with the digit positioned on the right representing the ones place value. The digit on the left is always a one, while the digit to the right is always one number smaller than the integer that was previously added to the nine. For example, in the equation 9+5, the sum is fourteen with the digit on the left being a one. The digit on the right is one less integer from the five that was added to the nine. The second icon preferably contains elements in its design that symbolize the thought process and/or series of steps leading to a solution. The second icon preferably includes a circle or circular object above an upright geometric shape (preferably that of a line or linear object) of slightly smaller proportion than the aforementioned circle. The preferred mnemonic device (i.e., the second icon) acts as a memory hook for the second mathematic concept in several ways. First, the shape of the second icon preferably resembles the appearance of the Arabic numeral 9, thereby establishing a non-arbitrary association between the second icon and the number 9. Second, students may be taught to associate the single circle in the appearance of the number 9 with the second mathematic concept's requirement that the digit in the ones place must be one integer less (or step down) from the number being added to the 9. Although the image of a lollypop 14 is given as an example of the second icon, other similar designs may be used such as, for example, a single balloon attached to a piece of string or a meatball above a stretched spaghetti noodle. Nonetheless, the mnemonic device that is non-arbitrarily associated with the second mathematic concept does not necessarily have to bear a resemblance to the Arabic numeral 9. A ladder with nine rungs or a necklace with nine beads will suffice as a mnemonic device for the same purpose. Students looking at the nine rungs of the ladder or the nine beads of the necklace would be reminded of nine and could see that one rung or bead down from any single digit number (as represented by rungs and beads) would result in a specific smaller number.

TABLE 2A
9 + 3 = 12
9 + 4 = 13
9 + 5 = 14
9 + 6 = 15
9 + 7 = 16
9 + 8 = 17
9 + 9 = 18

TABLE 2B
12 − 9 = 3
13 − 9 = 4
14 − 9 = 5
15 − 9 = 6
16 − 9 = 7
17 − 9 = 8
18 − 9 = 9

The third icon shown in FIG. 1 is given as an image of a bicycle 16. The third icon may be taught as a visual representation of adding eight units to a base unit (i.e., a third mathematic concept) and or subtracting eight units to a base unit (i.e., an eleventh mathematic concept). The association is non-arbitrary because the third icon (e.g., the bicycle 16) is visually similar to the Arabic numeral 8. In this particular embodiment, the third icon is also taught to be associated with a group of preferably about six equations for addition (Table 3A) and/or a group of preferably about six equations for subtraction (Table 3B). The groups of equations each represent a limited set of information that a student is encouraged to associate with the application of the third mathematic concept and/or the eleventh mathematic concept.

Any single digit integer (with the exception of zero and one) added to the number 8 will result in the answer being an integer in the teens. Thus, such sum is two digits with the digit positioned on the left representing the tens place value and the digit positioned on the right representing the ones place value. The digit on the left is always a one, while the digit on the right is always two integers smaller than the integer that was previously added to the eight. For example, in the equation 8+7, the sum is 15 with the digit on the left being a 1. The digit on the right being two integers less than the 7 that was added to the 8. A mnemonic device (e.g., the third icon) acts as a memory connector or memory hook and is taught to be non-arbitrarily associated with the third mathematic concept. The third icon contains elements in its design that symbolize, remind, and/or illustrate the thought process and/or series of steps leading to the solution of a problem involving the third mathematic concept. The third icon preferably includes an image of a bicycle 16. An image of a bicycle is preferably used because the two wheels of a bicycle resemble the Arabic numeral 8 rotated about 90 degrees or about 270 degrees. Additionally, a student may be taught to associate the two circles in the appearance of the numeral 8 with the third mathematic concept's requirement that the digit in the ones place must be two integers less (or steps down) from the integer being added to the 8. Although the image of a bicycle 16 is given as an example of the third icon, other similar designs may be used such as, for example, a two tiered cake resembling the number eight with the two tiers reminding a student to take two steps down in the ones place when adding. Nonetheless, the mnemonic device that is non-arbitrarily associated with the third mathematic concept does not necessarily have to bear a resemblance to the numeral 8. For example, an image of a group of eight children walking in a straight line with six of them being the same height and the last two being shorter could also be used.

TABLE 3A
8 + 3 = 11
8 + 4 = 12
8 + 5 = 13
8 + 6 = 14
8 + 7 = 15
8 + 8 = 16

TABLE 3B
11 − 8 = 3
12 − 8 = 4
13 − 8 = 5
14 − 8 = 6
15 − 8 = 7
16 − 8 = 8

The fourth icon shown in FIG. 1 is given as an image of a pair of substantially identical children 18. The fourth icon may be taught as a visual representation of adding a first number of units to an identical number of units (i.e., a fourth mathematic concept) because the fourth icon 18 (e.g., the pair of substantially identical children 18) is visually similar to two identical Arabic numerals being added to one another. In this particular embodiment, the fourth icon is also taught to be associated with a group of preferably about five equations such as the equations shown in Table 4A below, whereby the group of equations represents a limited set of information that a student is encouraged to associate with the application of the fourth mathematic concept.

Similarly, the fourth icon may also be used as a visual representation of a number that has already been doubled (e.g., a pair of identical twin children) using the fourth mathematic concept, but wherein the fourth icon is now also used as an associative tool to teach a twelfth mathematic concept of subtracting a number “n” from the number “n+n” or “2n”. In this particular embodiment, the fourth icon is also taught to be associated with a group of preferably about five equations such as the equations shown in Table 4B below, whereby the group of equations represents a limited set of information that a student is encouraged to associate with the application of the twelfth mathematic concept.

TABLE 4A
3 + 3 = 6
4 + 4 = 8
5 + 5 = 10
6 + 6 = 12
7 + 7 = 14

```
TABLE 4B
  6 − 3 = 3
  8 − 4 = 4
10 − 5 = 5
12 − 6 = 6
14 − 7 = 7
```

The fifth icon shown in FIG. 1 is given as an image of a pair of neighboring houses 20. The fifth icon may be taught as a visual representation of adding a first number of units represented by a first single digit integer (e.g., 6) to a second number of units represented by a neighboring second single digit integer (e.g., 7). A fifth mathematic concept includes this relationship of neighboring single digit integers as such integers are added together. A thirteenth mathematic concept includes the relationship of neighboring integers as such integers are subtracted from one another. The fifth icon is non-arbitrarily associated with the fifth mathematic concept because the fifth icon (e.g., the pair of neighboring houses 20) is analogous to two Arabic numeral integers that are adjacent to one another in increasing or decreasing sequence. In this particular embodiment, the fifth icon is also taught to be associated with a group of preferably about four addition equations (Table 5A) and/or a group of preferably about four subtraction equations (Table 5B). The groups of equations each represent a limited set of information that a student is encouraged to associate with the application of the fifth mathematic concept and/or the thirteenth mathematic concept.

Once a student has mastered the fourth mathematic concept, a student may be taught to associate a simple integer addition equation “n+n” (e.g., 3+3) with a second simple integer addition equation “n+(n+1)” (e.g., 3+4) and further taught to associate such a relationship with the fifth mathematic concept. This chain of logical association would dictate that the answer to the second simple integer equation is one integer higher than the answer to the first simple integer equation. Although the image of neighboring houses 20 is given as an example of the fifth icon, other similar designs may be used such as, for example, two different birds flying near each other. The objects used in any such image must be distinguishable from one another so that such objects are not confused with the mnemonic device associated with the fourth mathematic concept.

TABLE 5A
3 + 4 = 7
4 + 5 = 9
5 + 6 = 11
6 + 7 = 13

```
TABLE 5B
  7 − 3 = 4
  9 − 4 = 5
11 − 5 = 6
13 − 6 = 7
```

The sixth icon shown in FIG. 1 is given as an image of a walking cane. The sixth icon may be taught as a visual reminder of using some of the prior-taught mathematic concepts (i.e., the first mathematic concept, the second mathematic concept, the third mathematic concept, the fourth mathematic concept, and/or the fifth mathematic concept) as support for a sixth mathematic concept and/or using some of the other prior-taught mathematic concepts (i.e., the ninth mathematic concept, the tenth mathematic concept, the eleventh mathematic concept, the twelfth mathematic concept, and/or the thirteenth mathematic concept) as support for a fourteenth mathematic concept. The sixth icon is non-arbitrarily associated with the sixth mathematic concept and/or the fourteenth mathematic concept because the sixth icon (e.g., the walking cane 22) is analogous to support someone or something from a base using an intermediate structure. In this particular embodiment, the sixth icon is also taught to be associated with a group of preferably about six addition equations (Table 6A) and/or a group of preferably about six subtraction equations (Table 6B). The groups of equations each represent a limited set of information that a student is encouraged to associate with the application of the sixth mathematic concept and/or the fourteenth mathematic concept.

The chunk of information introduced as the sixth mathematic concept includes many of the single digit integer computations that do not fit into the previous mathematic concepts discussed above. By now a student understands adding or counting backwards one or two integers from a first integer because such student has applied these steps using the equations in Table 2A, table 3A, Table 2B, and Table 3B by using the second mathematic concept, the third mathematic concept, the tenth mathematic concept, and the eleventh mathematic concept. Such student has also learned to double single digits integers by using the equations associated with the fourth mathematic concept. Such student has also built on the fourth mathematic concept by recognizing that the fifth mathematic concept only differs from the fourth mathematic concept in that the sum in an equation associated with the fifth icon has a ones digit greater by one integer than the sum in an equation associated with the fourth icon. The image of a cane 22 for use as the sixth icon is preferred because, just as a person uses a cane for support when standing or walking, the sixth mathematic concept is premised on the previously learned mathematic concepts for support. Problems associated with the sixth mathematic concept have trouble standing on their own; as a group they have no unified pattern by which to simplify or solve. A student must now learn to add numbers where the counting involved is more than one or two. While it is important for a student to memorize basic math facts through practice and recall, it is equally important for such student to learn logic and problem solving methods. For example, when a student is dealing with a problem associated with the sixth mathematic concept (e.g., 6+4), instead of counting up the number 4 from the number 6, such student is taught to refer to previously learned mathematic concepts and associated equations. If such student knows that the equation of 4+4=8 associated with the fourth mathematic concept, then such student knows that the number 6 (which such student already knows is two more than the number 4) added to the number 4 will be two more than the number 8, thereby resulting in an answer of the number 10. Such student could also apply the equations associated with fifth mathematic concept such as equation 5+4=9 when solving the equation 6+4=x. With a problem like 7+3=x, however, referencing the fourth mathematic concept (e.g., 7+7=x or 3+3=x) does not simplify the problem. Nor does referencing equations associated with the fifth mathematic concept (e.g., 3+4=x or 6+7=x). The easiest way to solve the problem 7+3=x is for a student to recall the equation 2+7=9 associated with the first mathematic concept, so the answer “x” to 7+3=x must be a value that is one more integer than 9 (because the number 3 is one more integer than the number 2). Thus, “x” must equal the number 10.

The fourteenth mathematic concept is similar to the sixth mathematic concept because the fourteenth mathematic concept is built on lessons learned with regard to the ninth mathematic concept, the tenth mathematic concept, the eleventh mathematic concept, the twelfth mathematic concept, and the thirteenth mathematic concept. Unlike the sixth mathematic concept, however, subtraction is used instead of addition.

TABLE 6A
5 + 3 = 8
6 + 3 = 9
6 + 4 = 10
7 + 3 = 10
7 + 4 = 11
7 + 5 = 12

```
TABLE 6B
  8 − 5 = 3
  9 − 6 = 3
10 − 6 = 4
10 − 7 = 3
11 − 7 = 4
12 − 7 = 5
```

The seventh icon shown in FIG. 1 is given as an image as a rocket 24. The seventh icon is non-arbitrarily associated with a seventh mathematic concept of adding a single unit to a group of units. Similarly, the seventh icon is non-arbitrarily associated with a fifteenth mathematic concept of subtracting a single unit from a group of units. The seventh icon 24 is non-arbitrarily associated with the seventh mathematic concept and/or the fifteenth mathematic concept because the seventh icon (e.g., the rocket 24) is visually similar to the Arabic numeral 1. In a preferred embodiment, the seventh icon represents an object (e.g., a rocket) that is visually similar to the Arabic numeral 1 such that the object is oriented upward when addition is to be designated or such that the object is oriented downward when subtraction is to be designated. In this particular embodiment, the seventh icon is non-arbitrarily associated with a group of preferably about nine addition equations (Table 7A) and/or a group of preferably about nine subtraction equations (Table 7B). The groups of equations each represent a limited set of information that a student is encouraged to associate with the application of the seventh mathematic concept and/or the fifteenth mathematic concept.

TABLE 7A
0 + 1 = 1
0 + 2 = 2
0 + 3 = 3
0 + 4 = 4
0 + 5 = 5
0 + 6 = 6
0 + 7 = 7
0 + 8 = 8
0 + 9 = 9

TABLE 7B
1 − 0 = 1
2 − 0 = 2
3 − 0 = 3
4 − 0 = 4
5 − 0 = 5
6 − 0 = 6
7 − 0 = 7
8 − 0 = 8
9 − 0 = 9

The eighth icon shown in FIG. 1 is given as an image as a donut 26. The eighth icon is non-arbitrarily associated with an eighth mathematic concept of adding zero units to a group of units. Similarly, the eighth icon is non-arbitrarily associated with a sixteenth mathematic concept of subtracting zero units from a group of units. The eighth icon is non-arbitrarily associated with the eighth mathematic concept and/or the sixteenth mathematic concept because the eighth icon (e.g., the donut 26) is visually similar to the Arabic numeral 0. In this particular embodiment, the eighth icon is also taught to be associated with a group of preferably about nine addition equations (Table 8A) and/or a group of preferably about nine subtraction equations (Table 8B). The groups of equations each represent a limited set of information that a student is encouraged to associate with the application of the eighth mathematic concept and/or the sixteenth mathematic concept.

TABLE 8A
1 + 1 = 2
1 + 2 = 3
1 + 3 = 4
1 + 4 = 5
1 + 5 = 6
1 + 6 = 7
1 + 7 = 8
1 + 8 = 9
1 + 1 = 10

TABLE 8B
1 − 1 = 0
2 − 1 = 1
3 − 1 = 2
4 − 1 = 3
5 − 1 = 4
6 − 1 = 5
7 − 1 = 6
8 − 1 = 7
9 − 1 = 8
10 − 9 = 1

The embodiments of a method of using mnemonic tools to teach the mathematic concepts described above are designed to be built upon one another as a student develops his or her understanding of the mathematic concepts. Because the first mathematic concept described above is very similar to the ninth mathematic concept, the first mathematic concept and the ninth mathematic concept may be taught together for convenience using the same or similar mnemonic devices such as the first icon. However, it may be desirable to teach the broader concepts of addition and subtraction separately, thereby making it more prudent, for example, to teach the ninth mathematic concept separately from the first mathematic concept (and/or using separate and distinct mnemonic devices for teaching the first mathematic concept and the ninth mathematic concept, respectively). This reasoning for separating mathematic concepts related to subtraction by using different mnemonic devices (e.g., different icons) holds true for all of the mathematic concepts discussed above.

Although some of the examples of icons given above are visually similar to specific Arabic numerals, any mnemonic device that can be non-arbitrarily associated with a specific mathematic concept may be used. For example, instead of using a lollypop as an icon to associate with the Arabic numeral 9 and the second mathematic concept (and/or the tenth mathematic concept), a non-imitative icon may be used such as baseball because professional baseball games typically have nine innings.

In many of the embodiments described herein, mathematic concepts involving addition are preferably taught by the application of what is hereinafter referred to as the Efficient Addition Algorithm; mathematic concepts involving subtraction are preferably taught by the application of what is hereinafter referred to as the Efficient Subtraction Algorithm; mathematic concepts involving multiplication are preferably taught by the application of what is hereinafter referred to as the Efficient Multiplication Algorithm; and mathematic concepts involving division are preferably taught by the application of what is hereinafter referred to as the Efficient Division Algorithm (hereinafter, collectively, the “Efficient Algorithms”).

An example of the Efficient Addition Algorithm is demonstrated by reference to Example 1 below.

### EXAMPLE 1

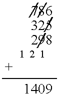

Numbers to be added together are preferably aligned vertically and the problem is worked from right to left on the page. Numbers in a given column are added from bottom to top. When two numbers in a column result in a sum equal or greater to ten, a slash mark is entered through the second number in that column. Thus instead of requiring a student to add the number 13 plus 6 in the first column of Example 1, a student must merely make a slash to represent 10 and then add 3 plus 6, resulting in the number 9 for the first column. The student then counts the number of slashes in the first column and places that number at the base of the next column. Continuing with the Example 1, because 1 plus 9 equals 10, a slash is placed through the number 9 in the second column. The number 2 added to 8 also results in the number 10, thus a slash is placed through the number 8 in column two, and a zero is placed in the tens place of the answer. Because two slashes are present in the second column, a small 2 is placed at the base of the third column. When the numbers 2, 2, and 3 are added to the number 7 in the third column, the sum is greater than ten. Thus, a slash is placed through the number 7, and the resulting 4 is placed in the hundreds place of the answer. Because one slash is present in the third column, a 1 is placed at the base of a fourth column and added to zero, resulting in a 1 being placed in the thousands place of the answer.

The Efficient Subtraction Algorithm is also known as the Austrian Algorithm or the Austrian Subtraction Algorithm. Because this particular algorithm is well known to a person of ordinary skill in the art, it will not be discussed in detail here.

The Efficient Multiplication Algorithm is illustrated by Example 2A-2F.

### EXAMPLE 2A

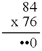

### EXAMPLE 2B

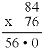

### EXAMPLE 2C

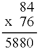

### EXAMPLE 2D

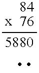

### EXAMPLE 2E

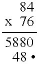

### EXAMPLE 2F

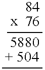

In the multiplication problem exemplified by Example 2A, the top number is commonly referred to as the multiplicand and the bottom number is commonly referred to as the multiplier. When the Efficient Multiplication Algorithm is used, a student first counts how many digits are to the right of the far left number of the multiplier to determine how many spaces (or, alternatively, zeros) should be included in the first row. After the spaces and/or zeros are accounted for, the student places a number of dots wherein the number directly corresponds to the number of digits in the multiplier. The student then multiplies the far left number of the multiplier times the far left number of the multiplicand. As shown in Example 2B, the result is 56—a two-digit number. The “6” of the resultant 56 is inserted in the place of the far left dot. Then, the far left number of the multiplier is multiplied by the next to the left number in the multiplicand (e.g., 7×4=28). The “8” of the resulting answer 28 is placed in the position next to where the far left dot was positioned. This results in the “2” of the 28 overlapping the “6” of the 56. The “2” is added to the “6”, resulting in a full answer of 5880 as shown in Example 2C. A student then places a number of dots corresponding to the total number of digits in the multiplier on a second row beneath the answer of 5880, wherein the second row of dots is moved over one digit from the former row of dots that were above it. The next digit to the right in the multiplier is then multiplied by the multiplicand and the process as before. When all digits of the multiplier have been multiplied by all digits of the multiplicand, the resulting answers to the intermediate multiplication problems may be added together to obtain the final answer, preferably using the Efficient Addition Algorithm.

The Efficient Division Algorithm includes division by factors as described by Flansburg et al. in Math Magic: The Human Calculator Shows How to Master Everyday Math Problems in Seconds, page 119 (1993), incorporated herein by reference. The Efficient Division Algorithm also includes elements of the Efficient Subtraction Algorithm and concepts used in the Efficient Multiplication Algorithm. The Efficient Division Algorithm can be broken down into at least two subcategories including the Efficient Long Division Algorithm and the Efficient Short Division Algorithm. The Efficient Short Division Algorithm is a process of solving division problems in which the divisor is 1, 2, 3, 4, 5, 6, 7, 8, or 9. Examples of short division using the Efficient Short Division Algorithm are illustrated in Example 4A, Example 4B, Example 5A and Example 5B, infra.

The Efficient Long Division Algorithm may be illustrated by the divisor 78 divided into the dividend 5904. The first step includes estimating how many times the number 78 will divide into the number 590. To simplify this process, students may round the number 78 up to the number 80. The number 8 will not divide into the number 5 to achieve an integer value, so the number 8 of 80 may be divided into the number 59 of 590. A student may recall that 8×7=56 and that 8×8=64. Since the number 64 is greater than 59, a best estimate for the first integer value in the quotient is 7.

### EXAMPLE 3A

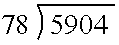

At this point, dots can be used for spacing purposes in similar fashion to how dots were used in the Efficient Multiplication Algorithm.

### EXAMPLE 3B

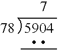

In the Efficient Long Division Algorithm (as with the Efficient Multiplication Algorithm) multiplication is performed from the left to right. Thus, the first number value of 49 (the product of 7×7) is placed in the place of the first dot as shown in Example 3C.

### EXAMPLE 3C

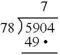

The product value of 56 (from 8×7) is them placed in the place of the next dot as shown in Example 3D. Because the 5 overlaps with the number 9, the five is temporarily written above the 9 as sown.

### EXAMPLE 3D

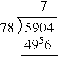

Then, the numbers 5 and 9 are combined to result in the number 14 as discussed above with regard to adding single digit integers to the number 9. The 1 from the 14 value is then added to the 4 resulting in the number 546 as shown in Example 3E below.

### EXAMPLE 3E

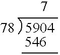

The number 546 is then subtracted from the number 590 using the Efficient Subtraction Algorithm, resulting in the number 44. The remaining 4 in 5904 is then brought down to form the number 444 as shown in Example 3F.

### EXAMPLE 3F

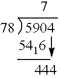

The divisor 78 is then divided into the number 444 in the same manner in which it was divided into 590 above. The resulting overall answer is shown in Example 3G below.

### EXAMPLE 3G

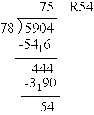

FIG. 2 shows another group of mnemonic devices in the form of icons 28 that are related to another set of embodiments of the method described herein. For example, a tenth icon shown in FIG. 2 is given as a pair of identical objects 30. In a preferred embodiment, the tenth icon is substantially identical to the fourth icon. The tenth icon may be taught as a visual representation of the doubling of a single digit integer to teach a seventeenth mathematic concept of obtaining the number “2n” as a result of doubling a number “n” wherein “n” is a single digit integer. In this particular embodiment, the tenth icon is also taught to be associated with a group of preferably about eight equations for doubling as shown in Table 9 below. The group of equations represents a limited set of information that a student is encouraged to associate with the application of the seventeenth mathematic concept.

TABLE 9

2 × 2 = 4
3 × 2 = 6
4 × 2 = 8
5 × 2 = 10
6 × 2 = 12
7 × 2 = 14
8 × 2 = 16
9 × 2 = 18

An eleventh icon shown in FIG. 2 is given as an image as a pair of substantially identical objects such as, for example, two pears 32. The eleventh icon may be taught as a visual representation of the doubling of a double digit integers (e.g., a pair of pears) to teach an eighteenth mathematic concept of obtaining the number “2n” as a result of doubling a number “n” wherein “n” is a double digit integer. In this particular embodiment, the eleventh icon is also taught to be associated with a group of preferably about seven equations for doubling as shown in Table 10 below, wherein the first digit (the ones place) equals 0, 1, 2, 3, or 4 prior to doubling. This group of equations represents a limited set of information that a student is encouraged to associate with the application of the eighteenth mathematic concept.

TABLE 10
10 × 2 = 20
11 × 2 = 22
12 × 2 = 24
13 × 2 = 26
14 × 2 = 28
20 × 2 = 40
21 × 2 = 42

A twelfth icon shown in FIG. 2 is given as an image of a pair of identical objects such as, for example, two cars 34. The twelfth icon may be taught as a visual representation of the doubling of a double digit integer (e.g., a pair of cars) to teach a nineteenth mathematic concept of obtaining the number “2n” as a result of doubling a number “n” wherein “n” is a double digit integer. In this particular embodiment, the twelfth icon is also taught to be associated with a group of preferably about seven equations for doubling as shown in Table 11 below, wherein the first digit (the ones place) equals 5, 6, 7, 8, or 9 prior to doubling. This group of equations represents a limited set of information that a student is encouraged to associate with the application of the nineteenth mathematic concept.

TABLE 11

15 × 2 = (10 × 2) + (5 × 2) = 30
16 × 2 = (10 × 2) + (6 × 2) = 32
17 × 2 = (10 × 2) + (7 × 2) = 34
18 × 2 = (10 × 2) + (8 × 2) = 36
19 × 2 = (10 × 2) + (9 × 2) = 38
25 × 2 = (20 × 2) + (5 × 2) = 50

The eighteenth mathematic concept and the nineteenth mathematic concept are distinguished because the nineteenth mathematic concept requires an extra algorithmic step—the first digit and the second digit (the ones place and the tens place, respectively) may not be simply doubled without carrying a value from the first digit to the second digit. Thus, the set of equations associated with the eleventh icon differs from the set of equations associated with the twelfth icon.

FIG. 3 shows another group of mnemonic devices in the form of icons 36 that are related to another set of embodiments of the method described herein. For example, a thirteenth icon may be given as an object that has been cut in half. The thirteenth icon may be taught as a visual representation of the halving of a single digit integer to teach a twentieth mathematic concept of obtaining the number “n” as a result of halving a number “2n” wherein “n” is a single digit integer. Alternatively, as shown in FIG. 3, the thirteenth icon may be single representation of a number “n” as compared to the number “2n” shown in FIG. 2 representing the tenth icon by showing a single object 38 as compared to a pair of objects. In this particular embodiment, the thirteenth icon is also taught to be associated with a group of preferably about eight equations for halving as shown in Table 12 below. The group of equations represents a limited set of information that a student is encouraged to associate with the application of the twentieth mathematic concept.

TABLE 12

```
  2 ÷ 2 = 1
  4 ÷ 2 = 2
  6 ÷ 2 = 3
  8 ÷ 2 = 4
10 ÷ 2 = 5
12 ÷ 2 = 6
14 ÷ 2 = 7
16 ÷ 2 = 8
18 ÷ 2 = 9
```

A fourteenth icon shown in FIG. 3 is given as an image of an object 40 that has been cut in half. The fourteenth icon may be taught as a visual representation of the halving of a double digit integer to teach a twenty-first mathematic concept of obtaining the number “n” as a result of halving a number “2n” wherein “n” is a double digit integer. Alternatively, the thirteenth icon may be a representation of a number “n” as compared to the number “2n” shown in the FIG. 2 representation of the eleventh icon 32 by showing a single object as compared to a pair of objects. In this particular embodiment, the fourteenth icon is also taught to be associated with a group of preferably about seven equations for halving as shown in Table 13 below, wherein the first digit (the ones place) equals 0, 2, 4, 6, or 8 prior to halving and wherein the second digit (the tens place) equals 2, 4, 6, or 8 prior to halving. The group of equations represents a limited set of information that a student is encouraged to associate with the application of the twenty-first mathematic concept.

TABLE 13

20 ÷ 2 = 10
22 ÷ 2 = 11
24 ÷ 2 = 12
26 ÷ 2 = 13
28 ÷ 2 = 14
40 ÷ 2 = 20
42 ÷ 2 = 21

A fifteenth icon shown in FIG. 3 is given as an image of an object 42 that has been cut in half. The fifteenth icon may be taught as a visual representation of the halving of a double digit integer to teach a twenty-second mathematic concept of obtaining the number “n” as a result of halving a number “2n” wherein “n” is a double digit integer. Alternatively, the thirteenth icon may be a representation of a number “n” as compared to the number “2n” shown in the FIG. 2 representation of the twelfth icon by showing a single object as compared to a pair of objects. In this particular embodiment, the fifteenth icon is also taught to be associated with a group of preferably about seven equations for halving as shown in Table 14 below, wherein the first digit (the ones place) equals 0, 2, 4, 6, or 8 prior to halving and wherein the second digit (the tens place) equals 3, 5, 7, or 9 prior to halving. The group of equations represents a limited set of information that a student is encouraged to associate with the application of the twenty-second mathematic concept.

TABLE 14

30 ÷ 2 = (20 ÷ 2) + (10 ÷ 2) = 15
32 ÷ 2 = (20 ÷ 2) + (12 ÷ 2) = 16
34 ÷ 2 = (20 ÷ 2) + (14 ÷ 2) = 17
36 ÷ 2 = (20 ÷ 2) + (16 ÷ 2) = 18
38 ÷ 2 = (20 ÷ 2) + (18 ÷ 2) = 19
50 ÷ 2 = (40 ÷ 2) + (10 ÷ 2) = 25

The twenty-first mathematic concept and the twenty-second mathematic concept are distinguishable because the twenty-first mathematic concept requires an extra algorithmic step—the first digit and the second digit (the ones place and the tens place, respectively) may not be simply halved without carrying a value from the first digit to the second digit. Thus, the set of equations associated with the fourteenth icon differs from the set of equations associated with the fifteenth icon. In some embodiments, the fourteenth icon may still nonetheless be substantially identical to the fifteenth icon as shown with the use of the halved pear in FIG. 3. Additionally, the thirteenth icon, the fourteenth icon and/or the fifteenth icon may be visual halved versions of the tenth icon, the eleventh icon, and/or the twelfth icon, respectively (as shown with regard to the tenth icon and the eleventh icon as compared to the fourteenth icon and the fifteenth icon in FIG. 2 and FIG. 3, respectively).

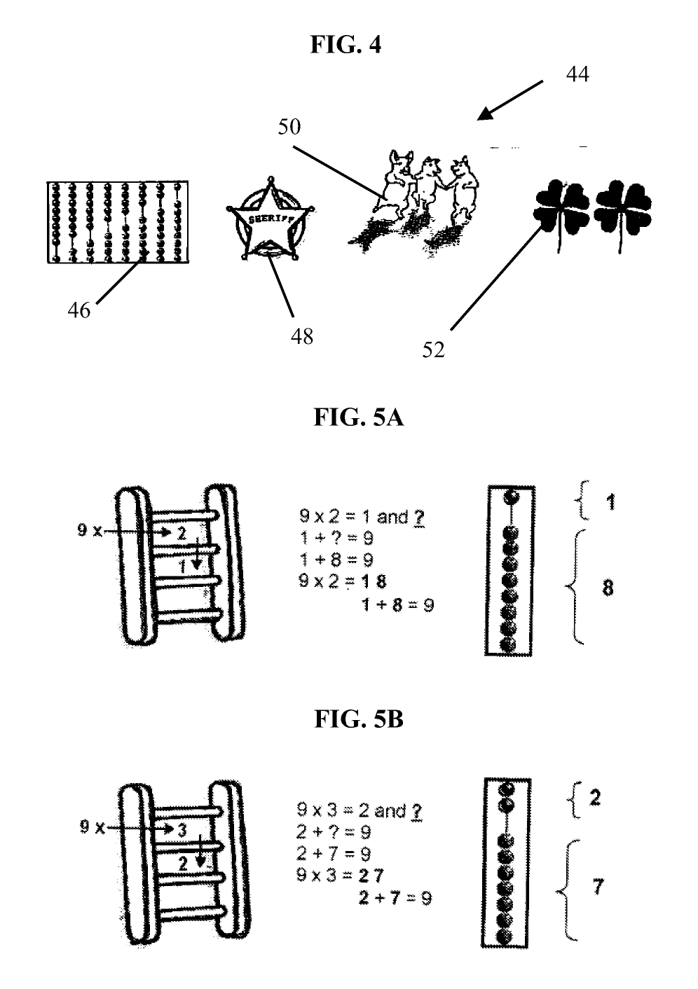

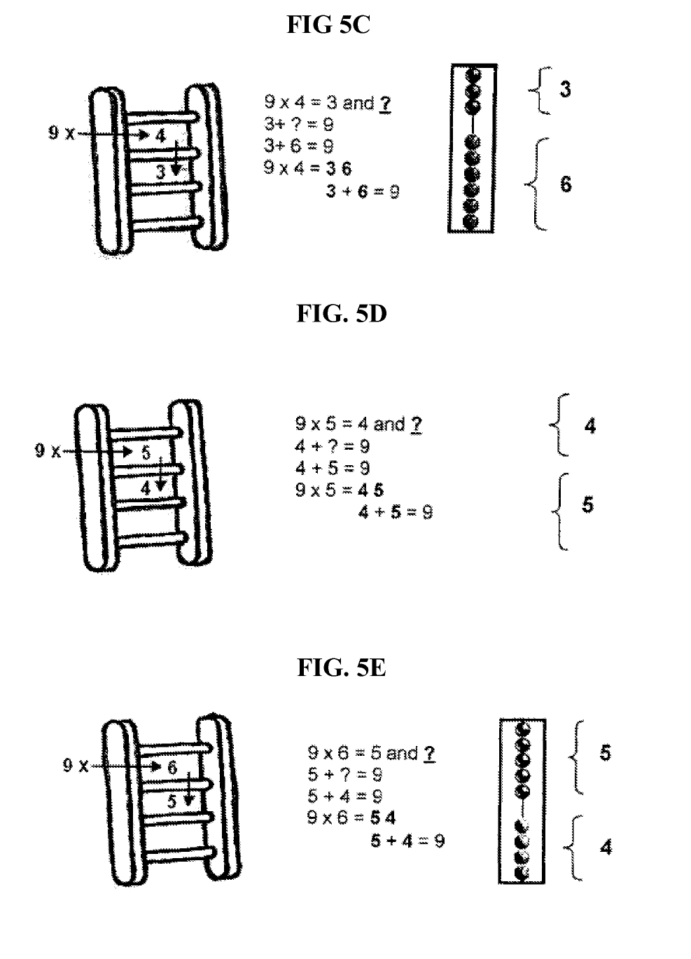

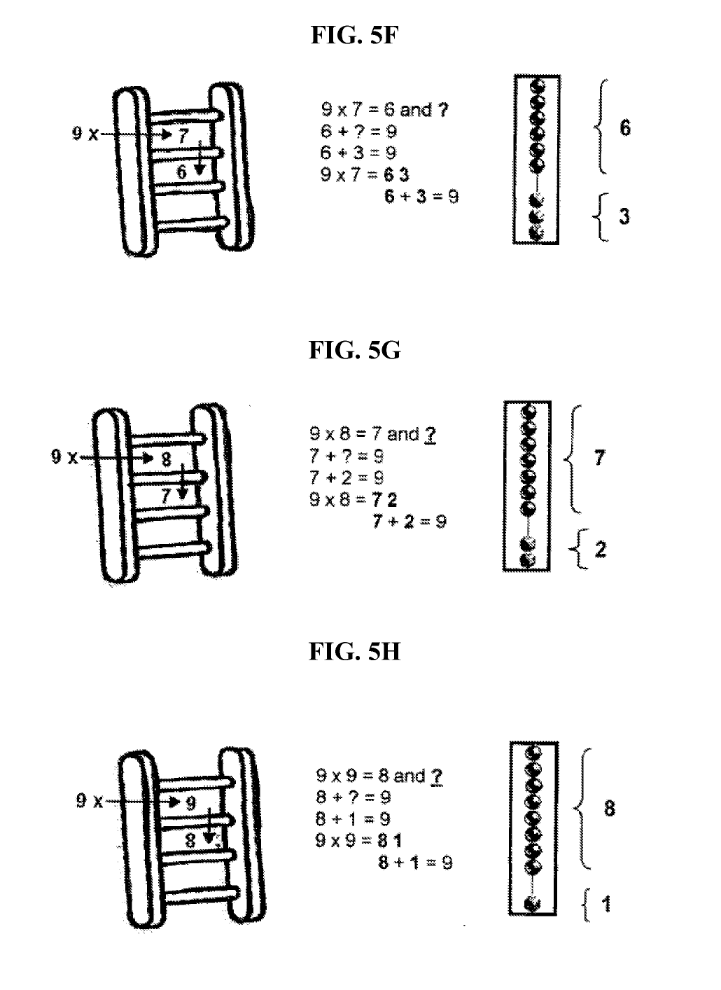

FIG. 4 shows another group of mnemonic devices in the form of icons 44 that are related to another set of embodiments of the method described herein. For example, a sixteenth icon shown in FIG. 4 is given as an image of an abacus 46 having nine beads per column. The sixteenth icon may be taught as a visual representation of a twenty-third mathematic concept regarding multiplying single digit integers by the number 9. The twenty-third mathematic concept includes the algorithm (“Abacus Method”) demonstrated in FIG. 5A through FIG. 5H that visually relate to an abacus. In this particular embodiment, the sixteenth icon is also taught to be associated with a group of preferably about eight equations for multiplying as shown in Table 15A below. This group of equations represents a limited set of information that a student is encouraged to associate with the application of the twenty-third mathematic concept.

The twenty-third mathematic concept includes the multiplication of the number 9 with any single digit integer. A student learning the twenty-third mathematic concept are preferably taught to use the abacus method to vastly simplify the twenty-third mathematic concept. When multiplying a number by nine, the digit in the tens place value of the answer will be one less than the number multiplying by. For example, in the problem 9×8=x, the answer “x” has two digits. Based on the Abacus Method the digit in the tens place value is one integer less than 8, making it 7. The way to find the answer for a digit in the ones place is just as simple. The beads of an abacus may be moved up or down a rod, depending on what sort of computation a person is performing. Normally an abacus has ten beads on a rod, but for the purposes of teaching the twenty-third mathematic concept, there will only be nine beads per rod. Using the equation 9×8=x as an example, the first digit previously determined as part of the answer is considered. Based on this first digit (i.e., 7), a student is taught to determine what must be added to the first digit to equal 9. The answer to this question will reveal the digit for the ones place. Because 7+2=9, then the number 2 goes in the ones place, and the full answer to the equation 9×8=x is x=72. The abacus as defined above plays a role in teaching the twenty-third mathematic concept as demonstrated in FIG. 5A through FIG. 5H. The beads above the space, or on top of the strand represent the number in the tens place. The beads below the space, or on the bottom of the strand, represent the number in the ones place. Each rod contains only nine beads, with enough space on the rod as to allow for the movement of the beads (up or down). The image of an abacus icon visually illustrates the thought method a student is taught to employ when solving a problem associated with the twenty-third mathematic concept. While an abacus as defined above is preferably used as the sixteenth icon, other objects, such as, for example, a necklace or a bracelet having nine beads, or a bowl containing nine marbles, may be used.

TABLE 15A

9 × 2 = 18
9 × 3 = 27
9 × 4 = 36
9 × 5 = 45
9 × 6 = 54
9 × 7 = 63
9 × 8 = 72
9 × 9 = 81

The sixteenth icon may also be taught as a visual representation of a twenty-seventh mathematic concept regarding dividing integers by the number 9. In this particular embodiment, the sixteenth icon is also taught to be associated with a group of preferably about eight equations for division as shown in Table 15B below. This group of equations represents a limited set of information that a student is encouraged to associate with the application of the twenty-seventh mathematic concept.

TABLE 15B

18 ÷ 9 = 2
27 ÷ 9 = 3
36 ÷ 9 = 4
45 ÷ 9 = 5
54 ÷ 9 = 6
63 ÷ 9 = 7
72 ÷ 9 = 8
81 ÷ 9 = 9

A seventeenth icon shown in FIG. 4 is given as an image of a five sided star inside a circle. The seventeenth icon 48 may be taught as a visual representation of a twenty-fourth mathematic concept regarding multiplying single digit integers by the number 5. In this particular embodiment, the seventeenth icon is also taught to be associated with a group of preferably about seven equations for multiplying as shown in Table 16A below. This group of equations represents a limited set of information that a student is encouraged to associate with the application of the twenty-fourth mathematic concept.

The seventeenth icon represents the multiplication of the number 5 by single digit integers. Because zero multiplied by a number always equals zero, and one multiplied by a number “x” always equals the number “x”, both zeros and ones are exceptions to the twenty-fourth mathematic concept. To simplify the learning and memorization of the equations associated with the twenty-fourth mathematic concept, such equations are preferably separated into two groups (Group A and Group B). Group A includes even single digit integers multiplied by 5 (i.e., 5×2, 5×4, 5×6, 5×8). Group B includes odd single digit integers multiplied by 5 (5×3, 5×5, 5×7). With regard to problems in which the number 5 is multiplied by an even number, a student is taught to consider the twentieth mathematic concept and to half the even number that is being multiplied by 5. The resulting single digit integer will be the answer for the tens place value, and the ones place value will always be zero. For example, in the problem 5×6=n, half of 6 is 3, so the number 3 goes in the tens place of the answer. The digit in the ones place value of the answer will always be a zero. So, the complete answer to the problem 5×6=30. With regard to problems in which the number 5 is multiplied by an odd number, a student is taught to consider what digit is one less than the digit in the problem. The answer will be an even digit. Taking the even digit and halving it results in the answer that goes in the tens place. The digit in the ones place will always be a five. For example, in the problem 5×7=n, a student is taught to determine what digit is one integer less than 7. One integer less than 7 is 6, and 6 halved equals 3. Five goes in the ones place and the answer to 5×7=35.

Preferably, the seventeenth icon includes an image of a five sided star inside of a circle 48. The circle reminds a student that when the number 5 is multiplied by an even single digit integer, the answer for the ones place value always ends with a zero. The five sided star reminds a student that when the number 5 is multiplied by an odd single digit integer the answer for the ones place value is always a five. Although the image of a five sided star inside a circle 48 is given as an example of the seventeenth icon, other similar designs may be used such as, for example, an image of a hand on top of a frisbee or an image of a gingerbread man cookie inside a donut.

TABLE 16A

5 × 2 = 10
5 × 3 = 15
5 × 4 = 20
5 × 5 = 25
5 × 6 = 30
5 × 7 = 35
5 × 8 = 40

The seventeenth icon may also be taught as a visual representation of a twenty-eighth mathematic concept regarding dividing integers by the number 5. In this particular embodiment, the seventeenth icon 48 is also taught to be associated with a group of preferably about seven equations for division as shown in Table 16B below. This group of equations represents a limited set of information that a student is encouraged to associate with the application of the twenty-eighth mathematic concept.

TABLE 16B

10 ÷ 5 = 2,
15 ÷ 5 = 3
20 ÷ 5 = 4
25 ÷ 5 = 5
30 ÷ 5 = 6
35 ÷ 5 = 7
40 ÷ 5 = 8

An eighteenth icon shown in FIG. 4 is given as an image of three dancing pigs 50. The eighteenth icon may be taught as a visual representation of a twenty-fifth mathematic concept regarding multiplying single digit integers by the numbers 3 or 6. The example of a three dancing pigs 50 is non-arbitrarily associated with the twenty-fifth mathematic concept because there are three pigs in the image, thus mentally triggering the number 3 in a person's mind. In this particular embodiment, the eighteenth icon is also taught to be associated with a group of preferably about six equations for multiplying as shown in Table 17A below. This group of equations represents a limited set of information that a student is encouraged to associate with the application of the twenty-fifth mathematic concept. Equations including the numbers 3 or 6 multiplied by the number 9 or 5 have been left out of Table 17A because they have already been covered by other mathematic concepts discussed above. Additionally, equations including the numbers 3 or 6 multiplied by the numbers 1 or 0 are not included in this icon group because they are exceptions to the twenty-fifth mathematic concept.

A student is encouraged to use knowledge and memory gathered from the seventeenth mathematic concept, the eighteenth mathematic concept, and the nineteenth mathematic concept to solve problems associate with the twenty-fifth mathematic concept. For example, if a student appreciates that 2×3 is the same as the number 3 doubled, then such student knows that 2×3=6. Such student should also appreciate that 2×6 is the same as the number 6 doubled. Students are taught to appreciate that because the number 6 is the double of the number 3, then every number “n” multiplied by 6 is double the value for the same number “n” multiplied by 3. For example, if 3×3=9, then 6×3=18, because 9 doubled=18. The problem 3×3=9 could also be presented as the counting by 3 (3, 6, 9) three times to get the answer 9. The image of the three little pigs 50 dancing with their shadows below them is preferred because the three pigs remind a student that multiplication problems involving the number 3 are being associated with the twenty-fifth mathematic concept, while the shadows look like a double image and therefore remind a student that multiplication problems involving the number 6 (the double of the number 3) are being associated with the twenty-fifth mathematic concept. The image of the three dancing pigs 50 is also reminiscent of a famous children's story involving three pigs and three houses. Although the image of three dancing pigs is given as an example of the eighteenth icon 50, other similar designs may be used such as, for example, three bears beside three beds (reminiscent of the famous children's story Goldie Locks and The Three Bears) because such an image could be taught to visually represent the numbers 3 and 6 to a student.

TABLE 17A

3 × 2 = 6
6 × 2 = 12
3 × 3 = 9
3 × 6 = 18
6 × 6 = 36
3 × 4 = 12
6 × 4 = 24
3 × 8 = 24
6 × 8 = 48
3 × 7 = 21
6 × 7 = 42

The eighteenth icon may also be taught as a visual representation of a twenty-ninth mathematic concept regarding dividing integers by the number 3 or 6. In this particular embodiment, the eighteenth icon is also taught to be associated with a group of preferably about eleven equations for division as shown in Table 17B below. This group of equations represents a limited set of information that a student is encouraged to associate with the application of the twenty-ninth mathematic concept.

TABLE 17B

```
  6 ÷ 3 = 2
12 ÷ 6 = 2
  9 ÷ 3 = 3
18 ÷ 3 = 6
36 ÷ 6 = 6
12 ÷ 3 = 4
24 ÷ 6 = 4
24 ÷ 3 = 8
48 ÷ 6 = 8
21 ÷ 3 = 7
42 ÷ 6 = 7
```

A nineteenth icon shown in FIG. 4 is given as an image of two four leaf clovers 52. The nineteenth icon may be taught as a visual representation of a twenty-sixth mathematic concept regarding multiplying single digit integers by the number 2, 4, or 8. The example of two four leaf clovers is non-arbitrarily associated with the twenty-sixth mathematic concept because there are two clovers, each clover has four leaves, and the total number of leaves is eight. Thus, an image of two four leaf clovers 52 is an example that could be used as the nineteenth icon to mentally triggering the numbers 2, 4, and/or 8 in a person's mind. In this particular embodiment, the nineteenth icon is also taught to be associated with a group of preferably about nine equations for multiplying as shown in Table 18A below. This group of equations represents a limited set of information that a student is encouraged to associate with the application of the twenty-sixth mathematic concept.

The image of two four leaf clovers 52 as used in a preferred embodiment for the nineteenth icon represents the multiplication of the numbers 2, 4, and 8 by single digit integers. It is important to note that none of the problems associated with the twenty-sixth mathematic concept are in any of the other multiplication icon groups. As with the eighteenth icon and the associated twenty-fifth mathematic concept, a student is encouraged to use knowledge and memory gathered from the seventeenth mathematic concept, the eighteenth mathematic concept, and the nineteenth mathematic concept to solve problems associated with the twenty-sixth mathematic concept. The image of two four leaf clovers 52 is preferred for use as the nineteenth icon because the image reminds a student that equations involving the numbers 2, 4 and 8 are involved. This non-arbitrary association is based on the fact that there are two clovers, each with four leaves for a total of eight leaves.

TABLE 18A

2 × 2 = 4
4 × 2 = 8
4 × 4 = 16
4 × 8 = 32
8 × 2 = 16
8 × 8 = 64
2 × 7 = 14
4 × 7 = 28
8 × 7 = 56

The nineteenth icon may also be taught as a visual representation of a thirtieth mathematic concept regarding dividing integers by the number 4 or 8. In this particular embodiment, the nineteenth icon is also taught to be associated with a group of preferably about ten equations for division as shown in Table 18B below. This group of equations represents a limited set of information that a student is encouraged to associate with the application of the thirtieth mathematic concept.

TABLE 18B

```
  4 ÷ 2 = 2
  8 ÷ 4 = 2
16 ÷ 4 = 4
32 ÷ 4 = 8
16 ÷ 8 = 2
32 ÷ 8 = 4
64 ÷ 8 = 8
14 ÷ 2 = 7
28 ÷ 4 = 7
56 ÷ 8 = 7
```

The one equation that does not fit into any of the multiplication mathematic concepts is 7×7=49. Though it has no specific associative mathematic concept defined above, a student is taught to remember that 6×7=42; therefore 7×7 will be 42+7 (i.e., 49). If for some reason 6×7 is not quickly recalled, the use of halving and doubling can be employed. The student may remember that 3×7=21, so 6×7 will be 21 doubled or 42. Then the student can add 7 to the 2 of the 42 thus arriving at the answer of 49 for the problem 7×7=n.

In a related embodiment, a method for teaching mathematics using mnemonic tools includes the steps of teaching and/or presenting at least one person on a first learning level (e.g., first grade) the first mathematic concept, the second mathematic concept, the third mathematic concept, the fourth mathematic concept, the fifth mathematic concept, the sixth mathematic concept, the seventh mathematic concept, and/or the eighth mathematic concept (hereinafter, collectively, the “Basic Addition Concepts”) using mnemonic devices such as a first icon, a second icon, a third icon, a fourth icon, a fifth icon, a sixth icon, a seventh icon, and/or an eighth icon; and the step of teaching and/or presenting a thirty-first mathematic concept of adding two-digit integers together using the logic of the Basic Addition Concepts wherein the second digit is zero. The method also preferably includes the step of teaching and/or presenting the addition of two two-digit integers together using the logic of the Basic Addition Concepts wherein the first digit of the first integer and the first digit of the second integer do not equal more than 9 when added together and wherein the second digit of the first integer and the second digit of the second integer do not equal more than 9 when added together a thirty-second mathematic concept. The method also preferably includes the step of teaching and/or presenting how to keep track of tens during the addition of a plurality of single digit integers wherein the sum of the plurality of integers equals a value of 10 or greater (a thirty-third mathematic concept).

Another embodiment of the invention described herein includes the steps of teaching and/or presenting (and/or reviewing with) at least one student on a second learning level (e.g., second grade) the Basic Addition Concepts using mnemonic devices such as icons; and the step of teaching and/or presenting a thirty-fourth mathematic concept of adding two-digit and/or three-digit integers together using the logic of the Basic Addition Concepts including how to keep track of tens during the addition process. The method also preferably includes teaching and/or presenting the addition equations associated with the Basic Addition Concepts, but altering the equations to include variables, thereby teaching and/or presenting basic algebra (a thirty-fifth mathematic concept). The method also preferably includes the steps of teaching and/or presenting the ninth mathematic concept, the tenth mathematic concept, the eleventh mathematic concept, the twelfth mathematic concept, the thirteenth mathematic concept, the fourteenth mathematic concept, the fifteenth mathematic concept, and/or the sixteenth mathematic concept (hereinafter, collectively, the “Basic Subtraction Concepts”) using mnemonic devices such as a first icon, a second icon, a third icon, a fourth icon, a fifth icon, a sixth icon, a seventh icon, and/or an eighth icon; and the step of teaching and/or presenting a thirty-sixth mathematic concept of subtracting two-digit integers from one another using the logic of the Basic Subtraction Concepts wherein the second digit is zero. The method also preferably includes the step of teaching and/or presenting the subtraction equations associated with the Basic Subtraction Concepts, but altering the equations to include variables, thereby teaching and/or presenting basic algebra (a thirty-seventh mathematic concept). The method also preferably includes the step of teaching and/or presenting the subtraction of two-digit or three-digit integers from two-digit or three-digit integers (a thirty-eighth mathematic concept).

Another embodiment of the invention described herein includes the steps of teaching and/or presenting (and/or reviewing with) at least one student on a third learning level (e.g., third grade) the Basic Addition Concepts and the Basic Subtraction Concepts using mnemonic devices such as icons; the step of teaching and/or presenting at least one person on a third learning level the seventeenth mathematic concept, the eighteenth mathematic concept, and the nineteenth mathematic concept (hereinafter, collectively, “Basic Doubling Concepts”); the step of teaching and/or presenting at least one person on a third learning level the twentieth mathematic concept, the twenty-first mathematic concept, and the twenty-second mathematic concept (hereinafter, collectively, “Basic Halving Concepts”); the step of teaching and/or presenting at least one person on a third learning level the twenty-third mathematic concept, the twenty-fourth mathematic concept, the twenty-fifth mathematic concept, and the twenty-sixth mathematic concept (hereinafter, collectively, “Basic Multiplication Concepts”) and the step of teaching and/or presenting a thirty-ninth mathematic concept of adding three-digit numbers together using the logic of the Basic Addition Concepts. The method also preferably includes the step of adding four-digit numbers to other numbers including the use of decimals placed in various locations within such numbers (a fortieth mathematic concept). The method also preferably includes the step of adding columns of three-digit numbers to each other including the use of decimals placed in various locations within such numbers (a forty-first mathematic concept). The method also preferably includes the step of teaching and/or presenting the addition equations associated with the Basic Addition Concepts, but altering the equations to include variables and to include two digit and three digit integers, thereby teaching and/or presenting basic algebra with two-digit and three-digit numbers (a forty-second mathematic concept). The method also preferably includes the step of teaching and/or presenting the addition of fractions having equal denominator values (a forty-third mathematic concept). The method also preferably includes the step of teaching and/or presenting a forty-fourth mathematic concept of subtracting three-digit numbers from three-digit or four-digit numbers using the logic of the Basic Subtraction Concepts. The method also preferably includes the step of teaching and/or presenting the subtraction of a first fraction from a second fraction using the logic of the Basic Subtraction Concepts wherein the denominator of the first fraction is the same value as the denominator of the second fraction (a forty-fifth mathematic concept). The method also preferably includes the step of teaching and/or presenting the subtraction equations associated with the Basic Subtraction Concepts, but altering the equations to include variables and to include two digit and three digit integers, thereby teaching and/or presenting basic algebra with two-digit and three-digit numbers (a forty-sixth mathematic concept). The method also preferably includes the step of subtracting three-digit numbers from other three-digit numbers including the use of decimals placed in various locations within such numbers (a forty-seventh mathematic concept). The method also preferably includes the steps of teaching and/or presenting a forty-eighth mathematic concept of multiplying a two-digit integer having a zero in the ones place together with a single digit integer using the logic of the Basic Doubling Concepts and/or Basic Multiplication Concepts. The method also preferably includes the step of teaching and/or presenting the multiplication of a two-digit or three-digit integer by a one-digit integer, preferably using the Efficient Algorithm (a forty-ninth mathematic concept). The method also preferably includes the step of teaching and/or presenting the association between multiplication and basic geometric theories such as equations relating to the perimeter and/or area of a geometric object (a fiftieth mathematic concept).

Another embodiment of the invention described herein includes the steps of teaching and/or presenting (and/or reviewing with) at least one student on a fourth learning level (e.g., fourth grade) the Basic Addition Concepts, the Basic Subtraction Concepts, the Basic Doubling Concepts, the Basic Halving Concepts, and the Basic Multiplication Concepts using mnemonic devices such as icons; teaching and/or presenting the twenty-seventh mathematic concept, the twenty-eighth mathematic concept, the twenty-ninth mathematic concept, and the thirtieth mathematic concept (hereinafter, collectively, the “Basic Division Concepts”) using mnemonic devices such as icons; and teaching and/or presenting a fifty-first mathematic concept of adding five-digit, six-digit, and/or seven-digit integers to other integers preferably using the Efficient Algorithm. The method also preferably includes the step of teaching and/or presenting the addition equations associated with the Basic Addition Concepts, but altering the equations to include variables and to include four-digit and five-digit integers, thereby teaching and/or presenting algebra with four-digit and five-digit integers (a fifty-second mathematic concept). The method also preferably includes the step of teaching and/or presenting the addition of four or more columns of numbers, wherein each number includes at least four digits (a fifty-third mathematic concept). The method also preferably includes the step of teaching and/or presenting the addition of a plurality decimals, each decimal including at least three digits (a fifty-fourth mathematic concept). The method also preferably includes the step of teaching and/or presenting the subtraction of a first large integer from a second large integer, wherein the first large integer and the second large integer each include between four and thirteen digits (a fifty-fifth mathematic concept). The method also preferably includes the step of teaching and/or presenting the subtraction equations associated with the Basic Subtraction Concepts, but altering the equations to include variables and to include four-digit and five-digit integers, thereby teaching and/or presenting algebra with four-digit and five-digit integers (a fifty-sixth mathematic concept). The method also preferably includes the step of teaching and/or presenting the subtraction of a first decimal from a second decimal, wherein the first decimal and the second decimal include at least three digits (a fifty-seventh mathematic concept). The method also preferably includes the step of teaching and/or presenting the multiplication of a three-digit integer by a two-digit integer preferably demonstrated using the Efficient Algorithm (fifty-eighth mathematic concept). The method also preferably includes the step of teaching and/or presenting long division with single digit divisors and two-digit (Example 4A) and/or three-digit (Example 4B) dividends (a fifty-ninth mathematic concept shown in Example 4A and Example 4B below).

### EXAMPLE 4A

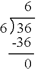

### EXAMPLE 4B

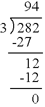

The method also preferably includes the step of teaching and/or presenting short division without written subtraction, with and/or without remainders (Example 5A), with single digit divisors and with four-digit or greater (Example 5B) dividends (a sixtieth mathematic concept shown in Example 5A and Example 5B below).

### EXAMPLE 5A

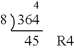

### EXAMPLE 5B

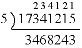

The method also preferably includes the step of teaching and/or presenting how to simplify fractions by dividing numerator and denominator by the same number (a sixty-first mathematic concept).

Another embodiment of the invention described herein includes the steps of teaching and/or presenting (and/or reviewing with) at least one student on a fifth learning level (e.g., fifth grade) the Basic Addition Concepts, the Basic Subtraction Concepts, the Basic Doubling Concepts, the Basic Halving Concepts, the Basic Multiplication Concepts, and the Basic Division Concepts using mnemonic devices such as icons; and the step of teaching and/or presenting a sixty-second mathematic concept of adding two or more fractions with at least one of the fractions having a denominator value that differs from the other denominator value(s). The method also preferably includes the step of teaching and/or presenting the subtraction of fractions from whole numbers (a sixty-third mathematic concept). The method also preferably includes the step of teaching and/or presenting the conversion of mixed fractions (e.g., 3¾) to simple fractions (e.g., 15/4) (a sixty-fourth mathematic concept). The method also preferably includes the step of teaching and/or presenting the subtraction of fractions from each other in which the fractions have denominators of different values (a sixty-fifth mathematic concept). The method also preferably includes the step of teaching and/or presenting the multiplication of a first three-digit (or greater) integer by a second three digit (or greater) integer, preferably demonstrated using the Efficient Algorithm (a sixty—sixth mathematic concept). The method also preferably includes the step of teaching and/or presenting the calculation of various geometric values including, but not limited to, the area of a circle, the circumference of a circle, the area of a trapezoid, the area of a triangle, the surface area of a cube, and/or the surface area of a rectangular prism using the logic of Basic Addition Concepts, the Basic Subtraction Concepts, the Basic Doubling Concepts, the Basic Halving Concepts, the Basic Multiplication Concepts, and/or the Basic Division Concepts (a sixty-seventh mathematic concept). The method also preferably includes the step of teaching and/or presenting various types of unit conversions including, but not limited to, the conversion of temperature, time, weight, length area, and volume using the logic of Basic Addition Concepts, the Basic Subtraction Concepts, the Basic Doubling Concepts, the Basic Halving Concepts, the Basic Multiplication Concepts, and/or the Basic Division Concepts (a sixty-eight mathematic concept). The method also preferably includes the step of teaching and/or presenting the multiplication of fractions (including mixed fractions and simple fractions) (a sixty-ninth mathematic concept). The method also preferably includes the step of teaching and/or presenting the multiplication of decimals in which such decimals include at least three digits (a seventieth mathematic concept). The method also preferably includes the step of teaching and/or presenting long division for problems in which the divisor does not factor as an integer (a seventy-first mathematic concept).

Another embodiment of the invention described herein includes the steps of teaching and/or presenting (and/or reviewing with) at least one student on a sixth learning level (e.g., sixth grade) the Basic Addition Concepts, the Basic Subtraction Concepts, the Basic Doubling Concepts, the Basic Halving Concepts, the Basic Multiplication Concepts, and the Basic Division Concepts using mnemonic devices such as icons; and the step of teaching and/or presenting a seventy-second mathematic concept including an introduction of ratios and percentages by using the Basic Addition Concepts. The method also preferably includes the step of teaching and/or presenting a seventy-third mathematic concept of ratios and percentages by using the Basic Subtraction Concepts. The method also preferably includes the step of teaching and/or presenting a seventy-fourth mathematic concept of ratios and percentages by using the Basic Multiplication Concepts, the cross multiplication of equivalent fractions to determine an unknown variable, and/or the conversion of a percentage to a decimal and/or a fraction. The method also preferably includes the step of teaching and/or presenting a seventy-fifth mathematic concept of dividing fractions by using multiplication. The method also preferably includes the step of teaching and/or presenting a seventy-sixth mathematic concept that includes long division with three-digit (or greater) divisors and three-digit (or greater) dividends. The method also preferably includes the step of teaching and/or presenting a seventy-seventh mathematic concept that includes the division of an integer by a fraction and/or a decimal. The method also preferably includes the step of teaching and/or presenting a seventy-eighth mathematic concept that includes the division of a three-digit (or greater) decimal by a three-digit (or greater) decimal. The method also preferably includes the step of teaching and/or presenting a seventy-ninth mathematic concept that includes the conversion of decimals to fractions and vice versa.

If not otherwise explicitly stated herein with regard to specific embodiments of the invention, it should be understood that every embodiment described herein involves teaching and/or presentation based on at least one of the Basic Addition Concepts, at least one of the Basic Subtraction Concepts, at least one of the Basic Doubling Concepts, at least one of the Basic Halving Concepts, at least one of the Basic Multiplication Concepts, and/or at least one of the Basic Division Concepts. The term “teaching” is used throughout this disclosure many times and this term is hereby defined broadly as any teaching method that includes the use of hardware, machinery, a computer and/or other teaching devices known to a person having ordinary skill in the art (i.e., any “presentation medium”). For example, a chalkboard could be used by a teacher to draw one or more mnemonic devices such as icons to non-arbitrarily associate such icons to specific mathematic concepts and specific equations related to such mathematic concepts as described herein. Similarly, a recording device (e.g., a tape recorder or a CD re-writable player) could be used to record and/or replay a mnemonic device in the form of a sound; a spray device (e.g., a pump action spray container) could be used spray a composition having a particular smell, wherein such smell could be used as a mnemonic device; and/or a computer could be used to run a program with specific learning modules that display or emit specific mnemonic devices as well as displaying particular equations or other indicia of the one or more mathematic concepts associated with the particular emitted mnemonic device(s) (e.g., an icon, a smell, a sound). The term “teacher” is not meant to be limited to any traditional notion of a person employed by or otherwise working for a school or a school system. Teaching is understood herein as a subcategory of presentation or presenting. The term “presenting” is more broadly defined as introducing a student to information using a methodology of steps that include a presentation medium. A presenting step may be accomplished without the requirement of a teacher. The term “student” as used herein is not meant to be limited to any traditional notion of a person attending a private or government sponsored school or school system.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method for teaching mathematics using mnemonic tools, the method comprising the step of presenting a first mnemonic tool for the purpose of teaching a first mathematic concept, wherein the first mathematic concept is non-arbitrarily associated with the first mnemonic tool, and wherein the first mnemonic tool is non-arbitrarily associated with a set of at least eight equations, the set of equations selected from the group consisting of:
2+2=4, 2+3=5, 2+4=6, 2+5=7, 2+6=8, 2+7=9, 2+8=10, and 2+9=11; a(1)
4−2=2, 5−2=3, 6−2=4, 7−2=5, 8−2=6, 9−2=7, 10−2=8, and 11−2=9; b(1)
2×2=4, 3×2=6, 4×2=8, 5×2=10, 6×2=12, 7×2=14, 8×2=16, and 9×2=18; c(1)
2÷2=1, 4÷2=2, 6÷2=3, 8÷2=4, 10÷2=5, 12÷2=6, 14÷2=7; 16÷2=8, and 18÷2=9; d(1).
9×2=18, 9×3=27, 9×4=36, 9×5=45, 9×6=54, 9×7=63, 9×8=72, and 9×9=81; and e(1)
18÷9=2, 27÷9=3, 36÷9=4, 45÷9=5, 54÷9=6, 63÷9=7, 72÷9=8, and 81÷9=9. f(1).

2. The method of claim 1 further comprising the step of presenting a second mnemonic tool for the purpose of teaching a second mathematic concept, wherein the second mathematic concept is non-arbitrarily associated with the second mnemonic tool, and wherein the second mnemonic tool is non-arbitrarily associated with a set of at least seven equations, the set of equations selected from the group consisting of:
9+3=12, 9+4=13, 9+5=14, 9+6=15, 9+7=16, 9+8=17, and 9+9=18; a(2)
12−9=3, 13−9=4, 14−9=5, 15−9=6, 16−9=7, 17−9=8, and 18−9=9; b(2)
10×2=20, 11×2=22, 12×2=24, 13×2=26, 14×2=28, 20×2=40, and 21×2=42; c(2)
20÷2=10, 22÷2=11, 24÷2=12, 26÷2=13, 28÷2=14, 40÷2=20, and 42÷2=21; d(2)
5×2=10, 5×3=15, 5×4=20, 5×5=25, 5×6=30, 5×7=35, and 5×8=40; and e(2)
10÷5=2, 15÷5=3, 20÷5=4, 25÷5=5, 30÷5=6, 35÷5=7, and 40÷5=8, f(2)
wherein the equations defined in a(2) are associated with the equations defined in a(1),
wherein the equations defined in b(2) are associated with the equations defined in b(1),
wherein the equations defined in c(2) are associated with the equations defined in c(1),
wherein the equations defined in d(2) are associated with the equations defined in d(1),
wherein the equations defined in e(2) are associated with the equations defined in e(1),
and wherein the equations defined in f(2) are associated with the equations defined in f(1).

3. The method of claim 2 further comprising the step of presenting a third mnemonic tool for the purpose of teaching a third mathematic concept, wherein the third mathematic concept is non-arbitrarily associated with the third mnemonic tool, and wherein the third mnemonic tool is non-arbitrarily associated with a set of at least six equations, the set of equations selected from the group consisting of:
8+3=11, 8+4=12, 8+5=13, 8+6=14, 8+7=15, and 8+8=16; a(3)
11−8=3, 12−8=4, 13−8=5, 14−8=6, 15−8=7, and 16−8=8; b(3)
15×2=(10×2)+(5×2)=30, 16×2=(10×2)+(6×2)=32, 17×2=(10×2)+(7×2)=34, 18×2=(10×2)+(8×2)=36, 19×2=(10×2)+(9×2)=38, and 25×2=(20×2)+(5×2)=50; c(3)
30÷2=(20÷2)+(10÷2)=15, 32÷2=(20÷2)+(12÷2)=16, 34÷2=(20÷2)+(14÷2)=17, 36÷2=(20÷2)+(16÷2)=18, 38÷2=(20÷2)+(18÷2)=19, and 50÷2=(40÷2)+(10÷2)=25; d(3)
3×2=6, 6×2=12, 3×3=9, 3×6=18, 6×6=36, 3×4=12, 6×4=24, 3×8=24, 6×8=48, 3×7=21, and 6×7=42; and e(3)
6÷3=2, 12÷6=2, 9÷3=3, 18÷3=6, 36÷6=6, 12÷3=4, 24÷6=4, 24÷3=8, 48÷6=8, 21÷3=7, and 42 6=7, f(3)
wherein the equations defined in a(3) are associated with the equations defined in a(2),
wherein the equations defined in b(3) are associated with the equations defined in b(2),
wherein the equations defined in c(3) are associated with the equations defined in c(2),
wherein the equations defined in d(3) are associated with the equations defined in d(2),
wherein the equations defined in e(3) are associated with the equations defined in e(2),
and wherein the equations defined in f(3) are associated with the equations defined in f(2).

4. The method of claim 3 further comprising the step of presenting a fourth mnemonic tool for the purpose of teaching a fourth mathematic concept, wherein the fourth mathematic concept is non-arbitrarily associated with the fourth mnemonic tool, and wherein the fourth mnemonic tool is non-arbitrarily associated with a set of at least five equations, the set of equations selected from the group consisting of:
3+3=6, 4+4=8, 5+5=10, 6+6=12, and 7+7=14; a(4)
6−3=3, 8−4=4, 10−5=5, 12−6=6, and 14−7=7; b(4)
2×2=4, 4×2=8, 4×4=16, 4×8=32, 8×2=16, 8×8=64, 2×7=14, 4×7=28, and 8×7=56; and c(4)
4÷2=2, 8÷4=2, 16÷4=4, 32÷4=8, 16÷8=2, 32÷8=4, 64÷8=8, 14÷2=7, 28÷4=7, and 56÷8=7, d(4).
wherein the equations defined in a(4) are associated with the equations defined in a(3),
wherein the equations defined in b(4) are associated with the equations defined in b(3),
wherein the equations defined in c(4) are associated with the equations defined in e(3),
and wherein the equations defined in d(4) are associated with the equations defined in f(3).

5. The method of claim 4 further comprising the step of presenting a fifth mnemonic tool for the purpose of teaching a fifth mathematic concept, wherein the fifth mathematic concept is non-arbitrarily associated with the fifth mnemonic tool, and wherein the fifth mnemonic tool is non-arbitrarily associated with a set of at least four equations, the set of equations selected from the group consisting of:
3+4=7, 4+5=9, 5+6=11, and 6+7=13; and a(5)
7−3=4, 9−4=5, 11−5=6, and 13−6=7, b(5).
wherein the equations defined in a(5) are associated with the equations defined in a(4),
and wherein the equations defined in b(5) are associated with the equations defined in b(4).

6. The method of claim 5 further comprising the step of presenting a sixth mnemonic tool for the purpose of teaching a sixth mathematic concept, wherein the sixth mathematic concept is non-arbitrarily associated with the sixth mnemonic tool, and wherein the sixth mnemonic tool is non-arbitrarily associated with a set of at least six equations, the set of equations selected from the group consisting of:
5+3=8, 6+3=9, 6+4=10, 7+3=10, 7+4=11, and 7+5=12; and a(6)
8−5=3, 9−6=3, 10−6=4, 10−7=3, 11−7=4, and 12−7=5, b(6)
wherein the equations defined in a(6) are associated with the equations defined in a(5), and wherein the equations defined in b(6) are associated with the equations defined in b(5).

7. The method of claim 6 further comprising the step of presenting a seventh mnemonic tool for the purpose of teaching a seventh mathematic concept, wherein the seventh mathematic concept is non-arbitrarily associated with the seventh mnemonic tool, and wherein the seventh mnemonic tool is non-arbitrarily associated with a set of at least nine equations, the set of equations selected from the group consisting of:
0+1=1, 0+2=2, 0+3=3, 0+4=4, 0+5=5, 0+6=6, 0+7=7, 0+8=8, and 0+9=9; and a(7)
1−0=1, 2−0=2, 3−0=3, 4−0=4, 5−0=5, 6−0=6, 7−0=7, 8−0=8, and 9−0=9, b(7).
wherein the equations defined in a(7) are associated with the equations defined in a(6),
and wherein the equations defined in b(7) are associated with the equations defined in b(6).

8. The method of claim 7 further comprising presenting an eighth mnemonic tool for the purpose of teaching an eighth mathematic concept, wherein the eighth mathematic concept is non-arbitrarily associated with the eighth mnemonic tool, and wherein the eighth mnemonic tool is non-arbitrarily associated with a set of at least nine equations, the set of equations selected from the group consisting of:
1+1=2, 1+2=3, 1+3=4, 1+4=5, 1+5=6, 1+6=7, 1+7=8, 1+8=9, and 1+9=10; and a(8)
1−1=0, 2−1=1, 3−1=2, 4−1=3, 5−1=4, 6−1=5, 7−1=6, 8−1=7, 9−1=8, and 10−1=9, b(8)
wherein the equations defined in a(8) are associated with the equations defined in a(7),
and wherein the equations defined in b(8) are associated with the equations defined in b(7).

9. The method of claim 3 wherein the third mnemonic tool is non-arbitrarily associated with a set of at least six equations, the set of equations selected from the group consisting of:
15×2=(10×2)+(5×2)=30, 16×2=(10×2)+(6×2)=32, 17×2=(10×2)+(7×2)=34, 18×2=(10×2)+(8×2)=36, 19×2=(10×2)+(9×2)=38, and 25×2=(20×2)+(5×2)=50; and c(3)
30÷2=(20÷2)+(10÷2)=15, 32÷2=(20÷2)+(12÷2)=16, 34÷2=(20÷2)+(14÷2)=17, 36÷2=(20÷2)+(16÷2)=18, 38÷2=(20÷2)+(18÷2)=19, and 50÷2=(40÷2)+(10÷2)=25, d(3)
and wherein the method of claim 3 further comprises the step of providing an exercise for the purpose of teaching a person to associate the first mnemonic tool with the first mathematic concept, to associate the second mnemonic tool with the second mathematic concept, and to associate the third mnemonic tool with the third mathematic concept.

10. The method of claim 4 wherein the fourth mnemonic tool is non-arbitrarily associated with a set of at least nine equations, the set of equations selected from the group consisting of:
2×2=4, 4×2=8, 4×4=16, 4×8=32, 8×2=16, 8×8=64, 2×7=14, 4×7=28, and 8×7=56; and c(4)
4÷2=2, 8÷4=2, 16÷4=4, 32÷4=8, 16÷8=2, 32÷8=4, 64÷8=8, 14÷2=7, 28÷4=7, and 56 8=7, d(4)
and wherein the method of claim 4 further comprises the step of providing an exercise for the purpose of teaching a person to associate the first mnemonic tool with the first mathematic concept, to associate the second mnemonic tool with the second mathematic concept, to associate the third mnemonic tool with the third mathematic concept, and to associate the fourth mnemonic tool with the fourth mathematic concept.

11. The method of claim 8 further comprising the step of providing an exercise for the purpose of teaching a person to associate the first mnemonic tool with the first mathematic concept, to associate the second mnemonic tool with the second mathematic concept, to associate the third mnemonic tool with the third mathematic concept, to associate the fourth mnemonic tool with the fourth mathematic concept, to associate the fifth mnemonic tool with the fifth mathematic concept, to associate the sixth mnemonic tool with the sixth mathematic concept, to associate the seventh mnemonic tool with the seventh mathematic concept, and to associate the eighth mnemonic tool with the eighth mathematic concept.

12. The method of claim 11 further comprising the subsequent steps of:
A. presenting the first mnemonic tool for the purpose of teaching a ninth mathematic concept, wherein the ninth mathematic concept is non-arbitrarily associated with the first mnemonic tool, and wherein the first mnemonic tool is non-arbitrarily associated with a set of at least eight equations including 4−2=2, 5−2=3, 6−2=4, 7−2=5, 8−2=6, 9−2=7, 10−2=8, and 11−2=9;
B. presenting the second mnemonic tool for the purpose of teaching a tenth mathematic concept, wherein the tenth mathematic concept is non-arbitrarily associated with the second mnemonic tool, and wherein the second mnemonic tool is non-arbitrarily associated with a set of at least seven equations including 12−9=3, 13−9=4, 14−9=5, 15−9=6, 16−9=7, 17−9=8, and 18−9=9;
C. presenting the third mnemonic tool for the purpose of teaching an eleventh mathematic concept, wherein the eleventh mathematic concept is non-arbitrarily associated with the third mnemonic tool, and wherein the third mnemonic tool is non-arbitrarily associated with a set of at least six equations including 11−8=3, 12−8=4, 13−8=5, 14−8=6, 15−8=7, and 16−8=8;
D. presenting the fourth mnemonic tool for the purpose of teaching a twelfth mathematic concept, wherein the twelfth mathematic concept is non-arbitrarily associated with the fourth mnemonic tool, and wherein the fourth mnemonic tool is non-arbitrarily associated with a set of at least five equations including 6−3=3, 8−4=4, 10−5=5, 12−6=6, and 14−7=7;
E. presenting the fifth mnemonic tool for the purpose of teaching a thirteenth mathematic concept, wherein the thirteenth mathematic concept is non-arbitrarily associated with the fifth mnemonic tool, and wherein the fifth mnemonic tool is non-arbitrarily associated with a set of at least four equations including 7−3=4, 9−4=5, 11−5=6, and 13−6=7;
F. presenting the sixth mnemonic tool for the purpose of teaching a fourteenth mathematic concept, wherein the fourteenth mathematic concept is non-arbitrarily associated with the sixth mnemonic tool, and wherein the sixth mnemonic tool is non-arbitrarily associated with a set of at least six equations including 8−5=3, 9−6=3, 10−6=4, 10−7=3, 11−7=4, and 12−7=5;
G. presenting the seventh mnemonic tool for the purpose of teaching a fifteenth mathematic concept, wherein the fifteenth mathematic concept is non-arbitrarily associated with the seventh mnemonic tool, and wherein the seventh mnemonic tool is non-arbitrarily associated with a set of at least nine equations including 1−0=1, 2−0=2, 3−0=3, 4−0=4, 5−0=5, 6−0=6, 7−0=7, 8−0=8, and 9−0=9;
H. presenting the eighth mnemonic tool for the purpose of teaching a sixteenth mathematic concept, wherein the sixteenth mathematic concept is non-arbitrarily associated with the eighth mnemonic tool, and wherein the eighth mnemonic tool is non-arbitrarily associated with a set of at least nine equations including −1=0, 2−1=1, 3−1=2, 4−1=3, 5−1=4, 6−1=5, 7−1=6, 8−1=7, 9−1=8, and 10−1=9; and
I. providing an exercise for the purpose of teaching a person to associate the first mnemonic tool with the ninth mathematic concept, to associate the second mnemonic tool with the tenth mathematic concept, to associate the third mnemonic tool with the eleventh mathematic concept, to associate the fourth mnemonic tool with the twelfth mathematic concept, to associate the fifth mnemonic tool with the thirteenth mathematic concept, to associate the sixth mnemonic tool with the fourteenth mathematic concept, to associate the seventh mnemonic tool with the fifteenth mathematic concept, and to associate the eighth mnemonic tool with the sixteenth mathematic concept.

13. The method of claim 11 further comprising the subsequent steps of:
A. presenting a ninth mnemonic tool for the purpose of teaching a ninth mathematic concept, wherein the ninth mathematic concept is non-arbitrarily associated with the ninth mnemonic tool, and wherein the ninth mnemonic tool is non-arbitrarily associated with a set of at least eight equations including 4−2=2, 5−2=3, 6−2=4, 7−2=5, 8−2=6, 9−2=7, 10−2=8, and 11−2=9;
B. presenting a tenth mnemonic tool for the purpose of teaching a tenth mathematic concept, wherein the tenth mathematic concept is non-arbitrarily associated with the tenth mnemonic tool, and wherein the tenth mnemonic tool is non-arbitrarily associated with a set of at least seven equations including 12−9=3, 13−9=4, 14−9=5, 15−9=6, 16−9=7, 17−9=8, and 18−9=9;
C. presenting an eleventh mnemonic tool for the purpose of teaching an eleventh mathematic concept, wherein the eleventh mathematic concept is non-arbitrarily associated with the eleventh mnemonic tool, and wherein the eleventh mnemonic tool is non-arbitrarily associated with a set of at least six equations including 11−8=3, 12−8=4, 13−8=5, 14−8=6, 15−8=7, and 16−8=8;
D. presenting a twelfth mnemonic tool for the purpose of teaching a twelfth mathematic concept, wherein the twelfth mathematic concept is non-arbitrarily associated with the twelfth mnemonic tool, and wherein the twelfth mnemonic tool is non-arbitrarily associated with a set of at least five equations including 6−3=3, 8−4=4, 10−5=5, 12−6=6, and 14−7=7;
E. presenting a thirteenth mnemonic tool for the purpose of teaching a thirteenth mathematic concept, wherein the thirteenth mathematic concept is non-arbitrarily associated with the thirteenth mnemonic tool, and wherein the thirteenth mnemonic tool is non-arbitrarily associated with a set of at least four equations including 7−3=4, 9−4=5, 11−5=6, and 13−6=7;
F. presenting a fourteenth mnemonic tool for the purpose of teaching a fourteenth mathematic concept, wherein the fourteenth mathematic concept is non-arbitrarily associated with the fourteenth mnemonic tool, and wherein the fourteenth mnemonic tool is non-arbitrarily associated with a set of at least six equations including 8−5=3, 9−6=3, 10−6=4, 10−7=3, 11−7=4, and 12−7=5;
G. presenting a fifteenth mnemonic tool for the purpose of teaching a fifteenth mathematic concept, wherein the fifteenth mathematic concept is non-arbitrarily associated with the fifteenth mnemonic tool, and wherein the fifteenth mnemonic tool is non-arbitrarily associated with a set of at least nine equations including 1−0=1, 2−0=2, 3−0=3, 4−0=4, 5−0=5, 6−0=6, 7−0=7, 8−0=8, and 9−0=9;
H. presenting a sixteenth mnemonic tool for the purpose of teaching a sixteenth mathematic concept, wherein the sixteenth mathematic concept is non-arbitrarily associated with the sixteenth mnemonic tool, and wherein the sixteenth mnemonic tool is non-arbitrarily associated with a set of at least nine equations including −1=0, 2−1=1, 3−1=2, 4−1=3, 5−1=4, 6−1=5, 7−1=6, 8−1=7, 9−1=8, and 10−1=9; and
I. providing an exercise for the purpose of teaching a person to associate the ninth mnemonic tool with the ninth mathematic concept, to associate the tenth mnemonic tool with the tenth mathematic concept, to associate the eleventh mnemonic tool with the eleventh mathematic concept, to associate the twelfth mnemonic tool with the twelfth mathematic concept, to associate the thirteenth mnemonic tool with the thirteenth mathematic concept, to associate the fourteenth mnemonic tool with the fourteenth mathematic concept, to associate the fifteenth mnemonic tool with the fifteenth mathematic concept, and to associate the sixteenth mnemonic tool with the sixteenth mathematic concept.

14. The method of claim 12 further comprising the steps of:
A. presenting a seventeenth mnemonic tool for the purpose of teaching a seventeenth mathematic concept, wherein the seventeenth mathematic concept is non-arbitrarily associated with the seventeenth mnemonic tool, and wherein the seventeenth mnemonic tool is non-arbitrarily associated with a set of at least eight equations including 2×2=4, 3×2=6, 4×2=8, 5×2=10, 6×2=12, 7×2=14, 8×2=16, and 9×2=18;
B. presenting an eighteenth mnemonic tool for the purpose of teaching an eighteenth mathematic concept, wherein the eighteenth mathematic concept is non-arbitrarily associated with the eighteenth mnemonic tool, and wherein the eighteenth mnemonic tool is non-arbitrarily associated with a set of at least seven equations including 10×2=20, 11×2=22, 12×2=24, 13×2=26, 14×2=28, 20×2=40, and 21×2=42;
C. presenting a nineteenth mnemonic tool for the purpose of teaching a nineteenth mathematic concept, wherein the nineteenth mathematic concept is non-arbitrarily associated with the nineteenth mnemonic tool, and wherein the nineteenth mnemonic tool is non-arbitrarily associated with a set of at least six equations including 15×2=(10×2)+(5×2)=30, 16×2=(10×2)+(6×2)=32, 17×2=(10×2)+(7×2)=34, 18×2=(10×2)+(8×2)=36, 19×2=(10×2)+(9×2)=38, and 25×2=(20×2)+(5×2)=50; and
D. providing an exercise for the purpose of teaching a person to associate the seventeenth mnemonic tool with the seventeenth mathematic concept, to associate the eighteenth mnemonic tool with the eighteenth mathematic concept, and to associate the nineteenth mnemonic tool with the nineteenth mathematic concept.

15. The method of claim 14 wherein the seventeenth mnemonic tool comprises a mnemonic tool that is substantially identical to the fourth mnemonic tool.

16. The method of claim 13 further comprising the steps of:
A. presenting a seventeenth mnemonic tool for the purpose of teaching a seventeenth mathematic concept, wherein the seventeenth mathematic concept is non-arbitrarily associated with the seventeenth mnemonic tool, and wherein the seventeenth mnemonic tool is non-arbitrarily associated with a set of at least eight equations including 2×2=4, 3×2=6, 4×2=8, 5×2=10, 6×2=12, 7×2=14, 8×2=16, and 9×2=18;
B. presenting an eighteenth mnemonic tool for the purpose of teaching an eighteenth mathematic concept, wherein the eighteenth mathematic concept is non-arbitrarily associated with the eighteenth mnemonic tool, and wherein the eighteenth mnemonic tool is non-arbitrarily associated with a set of at least seven equations including 10×2=20, 11×2=22, 12×2=24, 13×2=26, 14×2=28, 20×2=40, and 21×2=42;
C. presenting a nineteenth mnemonic tool for the purpose of teaching a nineteenth mathematic concept, wherein the nineteenth mathematic concept is non-arbitrarily associated with the nineteenth mnemonic tool, and wherein the nineteenth mnemonic tool is non-arbitrarily associated with a set of at least six equations including 15×2=(10×2)+(5×2)=30, 16×2=(10×2)+(6×2)=32, 17×2=(10×2)+(7×2)=34, 18×2=(10×2)+(8×2)=36, 19×2=(10×2)+(9×2)=38, and 25×2=(20×2)+(5×2)=50; and
D. providing an exercise for the purpose of teaching a person to associate the seventeenth mnemonic tool with the seventeenth mathematic concept, to associate the eighteenth mnemonic tool with the eighteenth mathematic concept, and to associate the nineteenth mnemonic tool with the nineteenth mathematic concept.

17. The method of claim 13 further comprising the steps of:
A. presenting a twentieth mnemonic tool for the purpose of teaching a twentieth mathematic concept, wherein the twentieth mathematic concept is non-arbitrarily associated with the twentieth mnemonic tool, and wherein the twentieth mnemonic tool is non-arbitrarily associated with a set of at least eight equations including 2÷2=1, 4÷2=2, 6÷2=3, 8÷2=4, 10÷2=5, 12÷2=6, 14÷2=7; 16÷2=8, and 18÷2=9;
B. presenting a twenty-first mnemonic tool for the purpose of teaching a twenty-first mathematic concept, wherein the twenty-first mathematic concept is non-arbitrarily associated with the twenty-first mnemonic tool, and wherein the twenty-first mnemonic tool is non-arbitrarily associated with a set of at least seven equations including 20÷2=10, 22÷2=11, 24÷2=12, 26÷2=13, 28÷2=14, 40÷2=20, and 42÷2=21;
C. presenting a twenty-second mnemonic tool for the purpose of teaching a twenty-second mathematic concept, wherein the twenty-second mathematic concept is non-arbitrarily associated with the twenty-second mnemonic tool, and wherein the twenty-second mnemonic tool is non-arbitrarily associated with a set of at least six equations including 30÷2=(20÷2)+(10÷2)=15, 32÷2=(20÷2)+(12÷2)=16, 34÷2=(20÷2)+(14÷2)=17, 36÷2=(20÷2)+(16÷2)=18, 38÷2=(20÷2)+(18÷2)=19, and 50÷2=(40÷2)+(10÷2)=25; and
D. providing an exercise for the purpose of teaching a person to associate the twentieth mnemonic tool with the twentieth mathematic concept, to associate the twenty-first mnemonic tool with the twenty-first mathematic concept, and to associate the twenty-second mnemonic tool with the twenty-second mathematic concept.

18. The method of claim 14 further comprising the steps of:
A. presenting a twentieth mnemonic tool for the purpose of teaching a twentieth mathematic concept, wherein the twentieth mathematic concept is non-arbitrarily associated with the twentieth mnemonic tool, and wherein the twentieth mnemonic tool is non-arbitrarily associated with a set of at least eight equations including 2÷2=1, 4÷2=2, 6÷2=3, 8÷2=4, 10÷2=5, 12÷2=6, 14÷2=7; 16÷2=8, and 18÷2=9;
B. presenting a twenty-first mnemonic tool for the purpose of teaching a twenty-first mathematic concept, wherein the twenty-first mathematic concept is non-arbitrarily associated with the twenty-first mnemonic tool, and wherein the twenty-first mnemonic tool is non-arbitrarily associated with a set of at least seven equations including 20÷2=10, 22÷2=11, 24÷2=12, 26÷2=13, 28÷2=14, 40÷2=20, and 42÷2=21;
C. presenting a twenty-second mnemonic tool for the purpose of teaching a twenty-second mathematic concept, wherein the twenty-second mathematic concept is non-arbitrarily associated with the twenty-second mnemonic tool, and wherein the twenty-second mnemonic tool is non-arbitrarily associated with a set of at least six equations including 30÷2=(20÷2)+(10÷2)=15, 32÷2=(20÷2)+(12÷2)=16, 34÷2=(20÷2)+(14÷2)=17, 36÷2=(20÷2)+(16÷2)=18, 38÷2=(20÷2)+(18÷2)=19, and 50÷2=(40÷2)+(10÷2)=25; and
D. providing an exercise for the purpose of teaching a person to associate the twentieth mnemonic tool with the twentieth mathematic concept, to associate the twenty-first mnemonic tool with the twenty-first mathematic concept, and to associate the twenty-second mnemonic tool with the twenty-second mathematic concept.

19. The method of claim 12 further comprising the steps of:
A. presenting a twenty-third mnemonic tool for the purpose of teaching a twenty-third mathematic concept, wherein the twenty-third mathematic concept is non-arbitrarily associated with the twenty-third mnemonic tool, and wherein the twenty-third mnemonic tool is non-arbitrarily associated with a set of at least eight equations including 9×2=18, 9×3=27, 9×4=36, 9×5=45, 9×6=54, 9×7=63, 9×8=72, and 9×9=81;
B. presenting a twenty-fourth mnemonic tool for the purpose of teaching a twenty-fourth mathematic concept, wherein the twenty-fourth mathematic concept is non-arbitrarily associated with the twenty-fourth mnemonic tool, and wherein the twenty-fourth mnemonic tool is non-arbitrarily associated with a set of at least seven equations including 5×2=10, 5×3=15, 5×4=20, 5×5=25, 5×6=30, 5×7=35, and 5×8=40;
C. presenting a twenty-fifth mnemonic tool for the purpose of teaching a twenty-fifth mathematic concept, wherein the twenty-fifth mathematic concept is non-arbitrarily associated with the twenty-fifth mnemonic tool, and wherein the twenty-fifth mnemonic tool is non-arbitrarily associated with a set of at least six equations including 3×2=6, 6×2=12, 3×3=9, 3×6=18, 6×6=36, 3×4=12, 6×4=24, 3×8=24, 6×8=48, 3×7=21, and 6×7=42;
D. presenting a twenty-sixth mnemonic tool for the purpose of teaching a twenty-sixth mathematic concept, wherein the twenty-sixth mathematic concept is non-arbitrarily associated with the twenty-sixth mnemonic tool, and wherein the twenty-sixth mnemonic tool is non-arbitrarily associated with a set of at least nine equations including 2×2=4, 4×2=8, 4×4=16, 4×8=32, 8×2=16, 8×8=64, 2×7=14, 4×7=28, and 8×7=56; and
E. providing an exercise for the purpose of teaching a person to associate the twenty-third mnemonic tool with the twenty-third mathematic concept, to associate the twenty-fourth mnemonic tool with the twenty-fourth mathematic concept, to associate the twenty-fifth mnemonic tool with the twenty-fifth mathematic concept, and to associate the twenty-sixth mnemonic tool with the twenty-sixth mathematic concept.

20. The method of claim 13 further comprising the steps of:
A. presenting a twenty-third mnemonic tool for the purpose of teaching a twenty-third mathematic concept, wherein the twenty-third mathematic concept is non-arbitrarily associated with the twenty-third mnemonic tool, and wherein the twenty-third mnemonic tool is non-arbitrarily associated with a set of at least eight equations including 9×2=18, 9×3=27, 9×4=36, 9×5=45, 9×6=54, 9×7=63, 9×8=72, and 9×9=81;
B. presenting a twenty-fourth mnemonic tool for the purpose of teaching a twenty-fourth mathematic concept, wherein the twenty-fourth mathematic concept is non-arbitrarily associated with the twenty-fourth mnemonic tool, and wherein the twenty-fourth mnemonic tool is non-arbitrarily associated with a set of at least seven equations including 5×2=10, 5×3=15, 5×4=20, 5×5=25, 5×6=30, 5×7=35, and 5×8=40;
C. presenting a twenty-fifth mnemonic tool for the purpose of teaching a twenty-fifth mathematic concept, wherein the twenty-fifth mathematic concept is non-arbitrarily associated with the twenty-fifth mnemonic tool, and wherein the twenty-fifth mnemonic tool is non-arbitrarily associated with a set of at least six equations including 3×2=6, 6×2=12, 3×3=9, 3×6=18, 6×6=36, 3×4=12, 6×4=24, 3×8=24, 6×8=48, 3×7=21, and 6×7=42;
D. presenting a twenty-sixth mnemonic tool for the purpose of teaching a twenty-sixth mathematic concept, wherein the twenty-sixth mathematic concept is non-arbitrarily associated with the twenty-sixth mnemonic tool, and wherein the twenty-sixth mnemonic tool is non-arbitrarily associated with a set of at least nine equations including 2×2=4, 4×2=8, 4×4=16, 4×8=32, 8×2=16, 8×8=64, 2×7=14, 4×7=28, and 8×7=56; and
E. providing an exercise for the purpose of teaching a person to associate the twenty-third mnemonic tool with the twenty-third mathematic concept, to associate the twenty-fourth mnemonic tool with the twenty-fourth mathematic concept, to associate the twenty-fifth mnemonic tool with the twenty-fifth mathematic concept, and to associate the twenty-sixth mnemonic tool with the twenty-sixth mathematic concept.

21. The method of claim 19 further comprising the steps of:
A. presenting the twenty-third mnemonic tool for the purpose of teaching a twenty-seventh mathematic concept, wherein the twenty-seventh mathematic concept is non-arbitrarily associated with the twenty-third mnemonic tool, and wherein the twenty-third mnemonic tool is non-arbitrarily associated with a set of at least eight equations including 18÷9=2, 27÷9=3, 36÷9=4, 45÷9=5, 54÷9=6, 63÷9=7, 72÷9=8, and 81÷9=9;
B. presenting the twenty-fourth mnemonic tool for the purpose of teaching a twenty-eighth mathematic concept, wherein the twenty-eighth mathematic concept is non-arbitrarily associated with the twenty-fourth mnemonic tool, and wherein the twenty-fourth mnemonic tool is non-arbitrarily associated with a set of at least seven equations including 10÷5=2, 15÷5=3, 20÷5=4, 25÷5=5, 30÷5=6, 35÷5=7, and 40÷5=8;
C. presenting the twenty-fifth mnemonic tool for the purpose of teaching a twenty-ninth mathematic concept, wherein the twenty-ninth mathematic concept is non-arbitrarily associated with the twenty-fifth mnemonic tool, and wherein the twenty-fifth mnemonic tool is non-arbitrarily associated with a set of at least eleven equations including 6÷3=2, 12÷6=2, 9÷3=3, 18÷3=6, 36÷6=6, 12÷3=4, 24÷6=4, 24÷3=8, 48÷6=8, 21÷3=7, and 42÷6=7;
D. presenting the twenty-sixth mnemonic tool for the purpose of teaching a thirtieth mathematic concept, wherein the thirtieth mathematic concept is non-arbitrarily associated with the twenty-sixth mnemonic tool, and wherein the twenty-sixth mnemonic tool is non-arbitrarily associated with a set of at least ten equations including 4÷2=2, 8÷4=2, 16÷4=4, 32÷4=8, 16÷8=2, 32÷8=4, 64÷8=8, 14÷2=7, 28÷4=7, and 56÷8=7; and
E. providing an exercise for the purpose of teaching a person to associate the twenty-third mnemonic tool with the twenty-seventh mathematic concept, to associate the twenty-fourth mnemonic tool with the twenty-eighth mathematic concept, to associate the twenty-fifth mnemonic tool with the twenty-ninth mathematic concept, and to associate the twenty-sixth mnemonic tool with the thirtieth mathematic concept.

22. The method of claim 19 further comprising the steps of:
A. presenting a twenty-seventh mnemonic tool for the purpose of teaching a twenty-seventh mathematic concept, wherein the twenty-seventh mathematic concept is non-arbitrarily associated with the twenty-seventh mnemonic tool, and wherein the twenty-seventh mnemonic tool is non-arbitrarily associated with a set of at least eight equations including 18÷9=2, 27÷9=3, 36÷9=4, 45÷9=5, 54÷9=6, 63÷9=7, 72÷9=8, and 81÷9=9;
B. presenting a twenty-eighth mnemonic tool for the purpose of teaching a twenty-eighth mathematic concept, wherein the twenty-eighth mathematic concept is non-arbitrarily associated with the twenty-eighth mnemonic tool, and wherein the twenty-eighth mnemonic tool is non-arbitrarily associated with a set of at least seven equations including 10÷5=2, 15÷5=3, 20÷5=4, 25÷5=5, 30÷5=6, 35÷5=7, and 40÷5=8;
C. presenting a twenty-ninth mnemonic tool for the purpose of teaching a twenty-ninth mathematic concept, wherein the twenty-ninth mathematic concept is non-arbitrarily associated with the twenty-ninth mnemonic tool, and wherein the twenty-ninth mnemonic tool is non-arbitrarily associated with a set of at least eleven equations including 6÷3=2, 12÷6=2, 9÷3=3, 18÷3=6, 36÷6=6, 12÷3=4, 24÷6=4, 24÷3=8, 48÷6=8, 21÷3=7, and 42÷6=7;
D. presenting a thirtieth mnemonic tool for the purpose of teaching a thirtieth mathematic concept, wherein the thirtieth mathematic concept is non-arbitrarily associated with the thirtieth mnemonic tool, and wherein the thirtieth mnemonic tool is non-arbitrarily associated with a set of at least ten equations including 4÷2=2, 8÷4=2, 16÷4=4, 32÷4=8, 16÷8=2, 32÷8=4, 64÷8=8, 14÷2=7, 28÷4=7, and 56÷8=7; and
E. providing an exercise for the purpose of teaching a person to associate the twenty-seventh mnemonic tool with the twenty-seventh mathematic concept, to associate the twenty-eighth mnemonic tool with the twenty-eighth mathematic concept, to associate the twenty-ninth mnemonic tool with the twenty-ninth mathematic concept, and to associate the thirtieth mnemonic tool with the thirtieth mathematic concept.

23. The method of claim 20 further comprising the steps of:
A. presenting the twenty-third mnemonic tool for the purpose of teaching a twenty-seventh mathematic concept, wherein the twenty-seventh mathematic concept is non-arbitrarily associated with the twenty-third mnemonic tool, and wherein the twenty-third mnemonic tool is non-arbitrarily associated with a set of at least eight equations including 18÷9=2, 27÷9=3, 36÷9=4, 45÷9=5, 54÷9=6, 63÷9=7, 72÷9=8, and 81÷9=9;
B. presenting the twenty-fourth mnemonic tool for the purpose of teaching a twenty-eighth mathematic concept, wherein the twenty-eighth mathematic concept is non-arbitrarily associated with the twenty-fourth mnemonic tool, and wherein the twenty-fourth mnemonic tool is non-arbitrarily associated with a set of at least seven equations including 10÷5=2, 15÷5=3, 20÷5=4, 25÷5=5, 30÷5=6, 35÷5=7, and 40÷5=8;
C. presenting the twenty-fifth mnemonic tool for the purpose of teaching a twenty-ninth mathematic concept, wherein the twenty-ninth mathematic concept is non-arbitrarily associated with the twenty-fifth mnemonic tool, and wherein the twenty-fifth mnemonic tool is non-arbitrarily associated with a set of at least eleven equations including 6÷3=2, 12÷6=2, 9÷3=3, 18÷3=6, 36÷6=6, 12÷3=4, 24÷6=4, 24÷3=8, 48÷6=8, 21÷3=7, and 42÷6=7;
D. presenting the twenty-sixth mnemonic tool for the purpose of teaching a thirtieth mathematic concept, wherein the thirtieth mathematic concept is non-arbitrarily associated with the twenty-sixth mnemonic tool, and wherein the twenty-sixth mnemonic tool is non-arbitrarily associated with a set of at least ten equations including 4÷2=2, 8÷4=2, 16÷4=4, 32÷4=8, 16÷8=2, 32÷8=4, 64÷8=8, 14÷2=7, 28÷4=7, and 56÷8=7; and
E. providing an exercise for the purpose of teaching a person to associate the twenty-third mnemonic tool with the twenty-seventh mathematic concept, to associate the twenty-fourth mnemonic tool with the twenty-eighth mathematic concept, to associate the twenty-fifth mnemonic tool with the twenty-ninth mathematic concept, and to associate the twenty-sixth mnemonic tool with the thirtieth mathematic concept.

24. The method of claim 20 further comprising the steps of:
A. presenting a twenty-seventh mnemonic tool for the purpose of teaching a twenty-seventh mathematic concept, wherein the twenty-seventh mathematic concept is non-arbitrarily associated with the twenty-seventh mnemonic tool, and wherein the twenty-seventh mnemonic tool is non-arbitrarily associated with a set of at least eight equations including 18÷9=2, 27÷9=3, 36÷9=4, 45÷9=5, 54÷9=6, 63÷9=7, 72÷9=8, and 81÷9=9;
B. presenting a twenty-eighth mnemonic tool for the purpose of teaching a twenty-eighth mathematic concept, wherein the twenty-eighth mathematic concept is non-arbitrarily associated with the twenty-eighth mnemonic tool, and wherein the twenty-eighth mnemonic tool is non-arbitrarily associated with a set of at least seven equations including 10÷5=2, 15÷5=3, 20÷5=4, 25÷5=5, 30÷5=6, 35÷5=7, and 40÷5=8;
C. presenting a twenty-ninth mnemonic tool for the purpose of teaching a twenty-ninth mathematic concept, wherein the twenty-ninth mathematic concept is non-arbitrarily associated with the twenty-ninth mnemonic tool, and wherein the twenty-ninth mnemonic tool is non-arbitrarily associated with a set of at least eleven equations including 6÷3=2, 12÷6=2, 9÷3=3, 18÷3=6, 36÷6=6, 12÷3=4, 24÷6=4, 24÷3=8, 48÷6=8, 21÷3=7, and 42÷6=7;
D. presenting a thirtieth mnemonic tool for the purpose of teaching a thirtieth mathematic concept, wherein the thirtieth mathematic concept is non-arbitrarily associated with the thirtieth mnemonic tool, and wherein the thirtieth mnemonic tool is non-arbitrarily associated with a set of at least ten equations including 4÷2=2, 8÷4=2, 16÷4=4, 32÷4=8, 16÷8=2, 32÷8=4, 64÷8=8, 14÷2=7, 28÷4=7, and 56÷8=7; and
E. providing an exercise for the purpose of teaching a person to associate the twenty-seventh mnemonic tool with the twenty-seventh mathematic concept, to associate the twenty-eighth mnemonic tool with the twenty-eighth mathematic concept, to associate the twenty-ninth mnemonic tool with the twenty-ninth mathematic concept, and to associate the thirtieth mnemonic tool with the thirtieth mathematic concept.
